(19) United States
(12) Patent Application Publication
(10) Pub. No.: US 2026/0112083 A1
(43) Pub. Date: Apr. 23, 2026

(54) FILM GRAIN SYNTHESIS

(71) Applicant: QUALCOMM Incorporated, San Diego, CA (US)

(72) Inventors: Khalid TAHBOUB, San Diego, CA (US); Yasutomo MATSUBA, San Diego, CA (US); Shengqi YANG, Carlsbad, CA (US); Kai WANG, San Diego, CA (US)

(21) Appl. No.: 18/918,547

(22) Filed: Oct. 17, 2024

(51) Int. Cl. G06T 11/60; B60K 35/22; G06T 3/40

(52) U.S. Cl. CPC G06T 11/60; B60K 35/22; G06T 3/40; G06T 2207/20204

(57) ABSTRACT

A device includes a memory configured to store film grain information. The device also includes one or more processors coupled to the memory and configured to downscale a first image frame having a first resolution to obtain a second image frame having a second resolution. The one or more processors are also configured to obtain, based on the film grain information, film grain data associated with the second resolution. The one or more processors are configured to output an output image frame based on the second image frame and the film grain data.

### I. FIELD

The present disclosure is generally related to film grain synthesis, such as film grain synthesis for video playback.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Digital video devices can implement video coding techniques to compress video data. Video coding is performed according to one or more video coding standards or formats. For example, video coding standards or formats include versatile video coding (VVC), high-efficiency video coding (HEVC), advanced video coding (AVC), MPEG-2 Part 2 coding (MPEG stands for moving picture experts group), Essential Video Coding (EVC), among others, as well as proprietary video coder-decoder (codecs)/formats such as AOMedia Video 1 (AV1) that was developed by the Alliance for Open Media. Video coding generally utilizes prediction methods (e.g., inter prediction, intra prediction, or the like) that take advantage of redundancy present in video images or sequences. A goal of video coding techniques is to compress video data into a form that uses a lower bit rate, while avoiding or minimizing degradations to video quality.

In the video/film industry, film grain generally refers to random optical texture that can appear in processed photographic films. For example, film grain is inherent in analog motion picture film due to the process of exposure and development of silver-halide crystals dispersed in photographic emulsion as randomly distributed grains appear at the locations where the silver crystals have formed. However, digital cameras do not produce film grain when generating digital video. To provide digital video with a “movie” look that can be aesthetically pleasing to a viewer, film grain is often added in post-production to digital video and can be considered part of the creative intent of a video work.

For digital video, film grain can be expensive to encode. A typical approach to efficiently preserve film grain can include denoising the source video and estimating the film grain parameters during encoding. It is noted that a film grain characteristics (FGC) supplemental enhancement information (SEI) message is specified in AVC, HEVC, and VVC to provide a decoder with a parameterized model for film grain synthesis. An encoder may use the FGC SEI message to characterize film grain that was present in the original source video material and was removed by pre-processing filtering techniques. Additionally, according to the typical approach, the film grain can later be synthesized from the parameters estimated at the encoder side and added to the reconstructed video during decoding. While performing post-processing, a decoder may use the FGC SEI message to simulate the film grain on the decoded images for the display process.

In conventional video playback scenarios, digital video is streamed to a decoder at a high resolution (e.g., 8K) and the video is output by the decoder for display at a lower resolution (e.g., 4K or 1080p). To provide the video at the lower resolution for optimal viewing at a display device, a downscaling operation can be performed on the video to downscale the video from the higher resolution to the lower resolution. When video decoding involves film grain synthesis and downscaling, the decoder may decode a video stream, perform film grain synthesis on the decoded video (at a full resolution), and then downscale the decoded video including film grain to generate a video output at a desired resolution. Performing the film grain synthesis at the full resolution can be power intensive. Additionally, or alternatively, downscaling after film grain synthesis can result in loss (associated with low pass filtering involved in the downscaling) of high frequency content which can remove or alter the film grain, produce unintended effects (e.g., artifacts), and/or reduce or diminish the creative intent of the film grain synthesis.

### III. SUMMARY

According to one implementation of the present disclosure, a device includes a memory configured to store film grain information. The device also includes one or more processors coupled to the memory. The one or more processors are configured to downscale a first image frame having a first resolution to obtain a second image frame having a second resolution, and obtain, based on the film grain information, film grain data associated with the second resolution. The one or more processors are also configured to output an output image frame based on the second image frame and the film grain data.

According to another implementation of the present disclosure, a method includes downscaling a first image frame having a first resolution to obtain a second image frame having a second resolution. The method also includes obtaining, based on film grain information, film grain data associated with the second resolution. The method further includes outputting an output image frame based on the second image frame and the film grain data.

According to another implementation of the present disclosure, a non-transitory computer-readable medium stores instructions that are executable by one or more processors to cause the one or more processors to downscale a first image frame having a first resolution to obtain a second image frame having a second resolution, and obtain, based on film grain information, film grain data associated with the second resolution. The instructions further cause the one or more processors to output an output image frame based on the second image frame and the film grain data.

According to another implementation of the present disclosure, an apparatus includes means for downscaling a first image frame having a first resolution to obtain a second image frame having a second resolution. The apparatus also includes means for obtaining, based on film grain information, film grain data associated with the second resolution. The apparatus further includes means for outputting an output image frame based on the second image frame and the film grain data.

According to another implementation of the present disclosure, a device includes a memory configured to store film grain information. The device also includes one or more processors coupled to the memory and configured to generate a representation of a first image frame having a first resolution. The one or more processors are also configured to generate the film grain information that indicates a first set of film grain parameters associated with the first resolution and a second set of film grain parameters associated with a second resolution that is different from the first resolution. The one or more processors are configured to output, to a decoder, output data that includes the representation of the first image frame and the film grain information.

According to another implementation of the present disclosure, a method includes generating a representation of a first image frame having a first resolution. The method also includes generating film grain information that indicates a first set of film grain parameters associated with the first resolution and a second set of film grain parameters associated with a second resolution that is different from the first resolution. The method further includes outputting, to a decoder, output data that includes the representation of the first image frame and the film grain information.

According to another implementation of the present disclosure, a non-transitory computer-readable medium stores instructions that are executable by one or more processors to cause the one or more processors to generate a representation of a first image frame having a first resolution. The instructions also cause the one or more processors to generate film grain information that indicates a first set of film grain parameters associated with the first resolution and a second set of film grain parameters associated with a second resolution that is different from the first resolution. The instructions further cause the one or more processors to output, to a decoder, output data that includes the representation of the first image frame and the film grain information.

According to another implementation of the present disclosure, an apparatus includes means for generating a representation of a first image frame having a first resolution. The apparatus also includes means for generating film grain information that indicates a first set of film grain parameters associated with the first resolution and a second set of film grain parameters associated with a second resolution that is different from the first resolution. The apparatus further includes means for outputting, to a decoder, output data that includes the representation of the first image frame and the film grain information.

According to another implementation of the present disclosure, a device includes a memory configured to store a first set of film grain parameters associated with a first resolution of a first image frame. The device also includes one or more processors coupled to the memory and configured to obtain the first set of film grain parameters associated with the first resolution. The one or more processors are also configured to apply a model to the first set of film grain parameters to generate a second set of film grain parameters associated with a second resolution of a second image frame. The second image frame is based on the first image frame.

According to another implementation of the present disclosure, a method includes obtaining a first set of film grain parameters associated with a first image frame having a first resolution. The method also includes applying a model to the first set of film grain parameters to obtain a second set of film grain parameters associated with a second image frame having a second resolution. The second image frame is based on the first image frame.

According to another implementation of the present disclosure, a non-transitory computer-readable medium stores instructions that are executable by one or more processors to cause the one or more processors to obtain a first set of film grain parameters associated with a first image frame having a first resolution. The instructions further cause the one or more processors to apply a model to the first set of film grain parameters to obtain a second set of film grain parameters associated with a second image frame having a second resolution. The second image frame is based on the first image frame.

According to another implementation of the present disclosure, an apparatus includes means for obtaining a first set of film grain parameters associated with a first image frame having a first resolution. The apparatus also includes means for applying a model to the first set of film grain parameters to obtain a second set of film grain parameters associated with a second image frame having a second resolution. The second image frame is based on the first image frame.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system that supports film grain synthesis, in accordance with one or more aspects of the present disclosure.

FIG. 2 is a diagram of an example of a video decoder that supports film grain synthesis, in accordance with some aspects of the present disclosure.

FIG. 3 is a diagram of an example of a method of operation of a video decoder, in accordance with some aspects of the present disclosure.

FIG. 4 is a diagram to illustrate an example of generation of film grain parameters, in accordance with some aspects of the present disclosure.

FIG. 5 is a diagram of an example of a video encoder that supports generation of film grain parameters, in accordance with some aspects of the present disclosure.

FIG. 6 is a diagram of another example of a video encoder that supports generation of film grain parameters, in accordance with some aspects of the present disclosure.

FIG. 7 is a diagram of an example of an integrated circuit operable to support film grain synthesis, in accordance with some examples of the present disclosure.

FIG. 8 is a diagram of a mobile device operable to support film grain synthesis, in accordance with some examples of the present disclosure.

FIG. 9 is a diagram of a wearable electronic device operable to support film grain synthesis, in accordance with some examples of the present disclosure.

FIG. 10 is a diagram of a voice-controlled speaker system operable to support film grain synthesis, in accordance with some examples of the present disclosure.

FIG. 11 is a diagram of a camera operable to support film grain synthesis, in accordance with some examples of the present disclosure.

FIG. 12 is a diagram of a headset, such as a virtual reality, mixed reality, or augmented reality headset, operable to support film grain synthesis, in accordance with some examples of the present disclosure.

FIG. 13 is a diagram of a first example of a vehicle operable to support film grain synthesis, in accordance with some examples of the present disclosure.

FIG. 14 is a diagram of a mixed reality or augmented reality glasses device operable to support film grain synthesis, in accordance with some examples of the present disclosure.

FIG. 15 is a diagram of a second example of a vehicle operable to support film grain synthesis, in accordance with some examples of the present disclosure.

FIG. 16 is a diagram of an example of a method of film grain synthesis, in accordance with some aspects of the present disclosure.

FIG. 17 is a diagram of an example of a method of film grain parameter generation, in accordance with some aspects of the present disclosure.

FIG. 18 is a diagram of an example of another method of film grain parameter generation, in accordance with some aspects of the present disclosure.

FIG. 19 is a block diagram of an illustrative example of a device that is operable to support film grain synthesis, in accordance with one or more aspects of the present disclosure.

### V. DETAILED DESCRIPTION

The present disclosure provides systems, apparatus, methods, and computer-readable media for film grain synthesis. The above-described problems associated with performing film grain synthesis on the decoded video (at a full resolution) are solved by determining film grain parameters associated with a resolution other than the full resolution and/or applying the film grain parameters on a downscaled version of the decoded video as described herein. For example, a video decoder device may receive, from an encoder device, film grain information that indicates first film grain parameters associated with a first resolution (e.g., a full resolution), or indicates the first film grain parameters and second film grain parameters associated with a second resolution (e.g., a lower resolution than the full resolution). If the film grain information includes the first film grain parameters, and not the second film grain parameters, the decoder device may generate the second film grain parameters based on the first film grain parameters to generate an output image frame (at the second resolution) that includes film grain. Alternatively, if the film grin information includes the second film grain parameters, the decoder device may use the received film grain parameters to generate the output image frame (at the second resolution) that includes the film grain.

Particular implementations of the subject matter described in this disclosure can be implemented to realize one or more of the following potential technical advantages. In some aspects, the present disclosure provides techniques for supporting film grain synthesis. For example, the video decoder device may perform downscaling on decoded video and then add film grain data to the downscaled video. To illustrate, the video decoder device may identify the film grain parameters (associated with an output resolution) provided in bitstream data from an encoder device, or may generate the film grain parameters (associated with an output resolution) based on other film grain parameters (associated with the full resolution) included in the bitstream data. The identification or generation of the film grain parameters enable the film grain data to be added to the downscaled video frame having the output resolution, which may reduce power consumption and improve an image quality of the output image frame as compared performing film grain synthesis on an image frame and then downscaling the image frame (having film grain) to generate the output image frame.

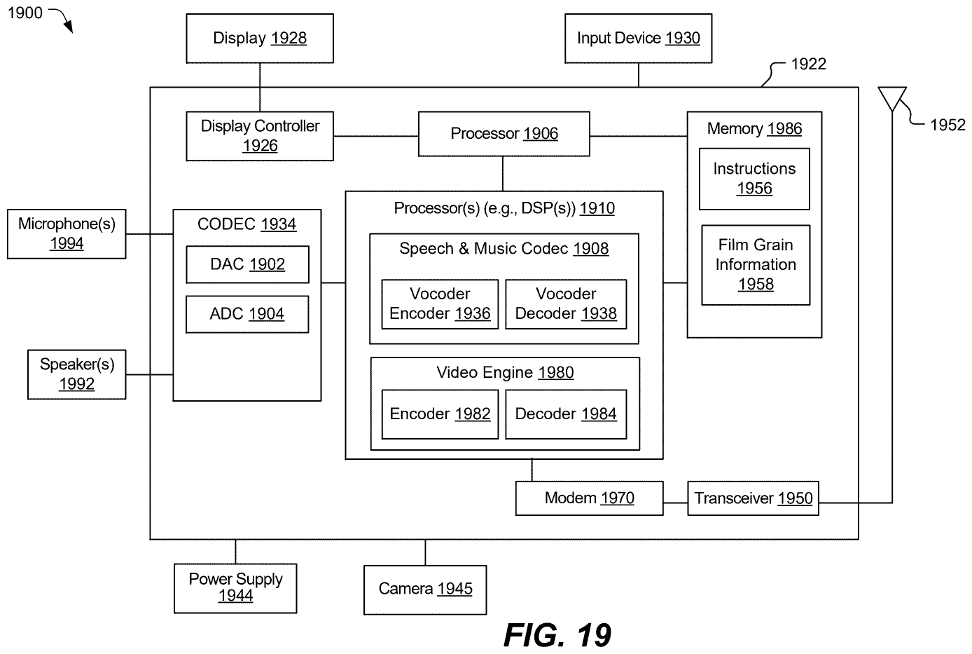

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 19 depicts a device 1900 including one or more processors (“processor(s)” 1910 of FIG. 19), which indicates that in some implementations the device 1900 includes a single processor 1910 and in other implementations the device 1900 includes multiple processors 1910. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 5, multiple film grain estimators are illustrated and associated with reference numbers 518A and 518B. When referring to a particular one of these film grain estimators, such as a film grain estimator 518A, the distinguishing letter “A” is used. However, when referring to any arbitrary one of these film grain estimators or to these film grain estimators as a group, the reference number 518 is used without a distinguishing letter.

As used herein, the terms “comprise,” “comprises,” and “comprising” may be used interchangeably with “include,” “includes,” or “including.” Additionally, the term “wherein” may be used interchangeably with “where”. As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Video coding devices implement video compression techniques to encode and decode video data. For example, digital video devices can implement video compression techniques, such as those described in the standards defined by MPEG-2, MPEG-4, ITU-T H.263, ITU-T H.264/MPEG-4, Advanced Video Coding (AVC), the High Efficiency Video Coding (HEVC) standard, and extensions of such standards. Video compression techniques may include applying different prediction modes, including spatial prediction (e.g., intra-frame prediction or intra-prediction), temporal prediction (e.g., inter-frame prediction or inter-prediction), inter-layer prediction (across different layers of video data), and/or other prediction techniques to reduce or remove redundancy inherent in video sequences.

As used herein, “coding” refers to “encoding” and “decoding.” Additionally, as used herein, the term “video coder” refers generically to both video encoders and video decoders. Further, in this disclosure, the terms “video coding” or “coding” may refer generically to video encoding or video decoding. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications.

A video encoder may generate a bitstream that includes an encoded representation of video data. For example, the video encoder can partition each picture of an original video sequence into rectangular regions referred to as video blocks or coding units. To illustrate, the bitstream may include a series of network abstraction layer (NAL) units. A NAL unit may be a syntax structure containing an indication of the type of data in the NAL unit and bytes containing that data in the form of a raw byte sequence payload (RBSP) interspersed as necessary with emulation prevention bits. The NAL units may include video coding layer (VCL) NAL units and non-VCL NAL units. The VCL NAL units may include coded slices of pictures. A non-VCL NAL unit may encapsulate a video parameter set (VPS), a sequence parameter set (SPS), a picture parameter set (PPS), one or more supplemental enhancement information (SEI) messages, or other types of data.

A film grain characteristics (FGC) supplemental enhancement information (SEI) message is specified in video codecs, such as AVC, HEVC, or Versatile Video Coding (VVC), to provide a decoder with a parameterized model for film grain synthesis. For example, the encoder may use the FGC SEI message to characterize film grain that was present in the original source video material and was removed by pre-processing filtering techniques. The FGC SEI message provides a decoding device with a parameterized model for film grain synthesis. While performing post-processing, the decoder may use the FGC SEI message to simulate the film grain on the decoded images for the display process. The Society of Motion Picture and Television Engineers (SMPTE) Registered Disclosure Document (RDD) 5 provides film grain technology specifications for video bitstreams (e.g., H.264/AVC bitstreams).

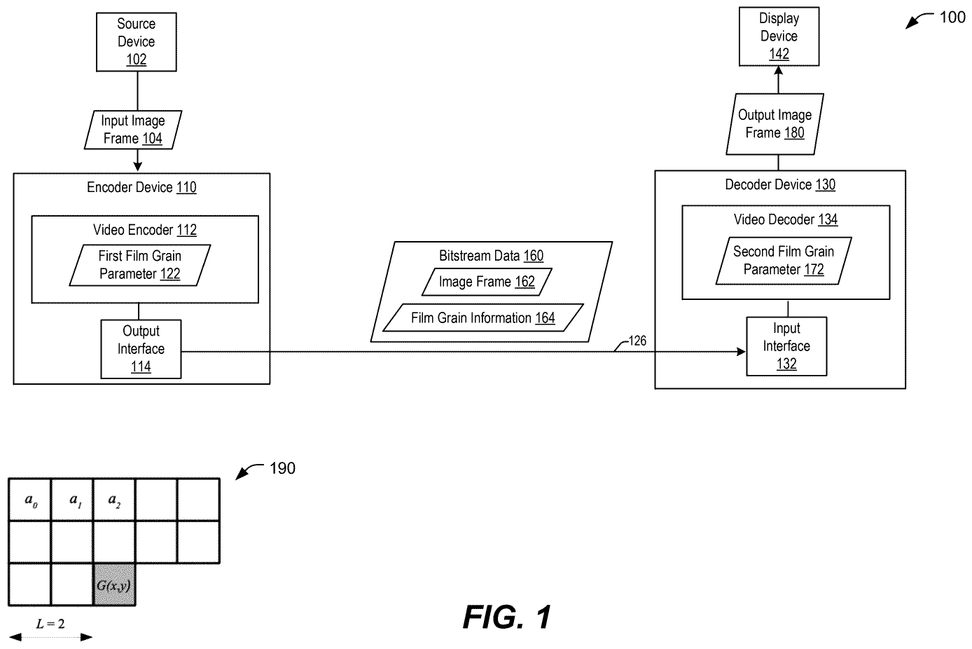

FIG. 1 is a block diagram of an example of a system 100 that supports film grain synthesis, in accordance with one or more aspects of the present disclosure. The system 100 can support one-way or two-way transmission (e.g., video transmission) to support applications such as video conferencing, video streaming, video playback, video broadcasting, gaming, and/or video telephony.

The system 100 includes a source device 102, an encoder device 110, a decoder device 130, and a display device 142. Although the system 100 is described as including the encoder device 110 and the decoder device 130, in other implementations, the system 100 may include one of the encoder device 110 and the decoder device 130, and not the other of the encoder device 110 and the decoder device 130. Each of the encoder device 110 and the decoder device 130 may be configured to support film grain synthesis. For example, the encoder device 110 may be configured to generate film grain parameters associated with film grain synthesis. As another example, the decoder device 130 may be configured to generate film grain parameters associated with film grain synthesis, perform film grain synthesis, or a combination thereof. Additionally, or alternatively, although the system is described as including the source device 102 and the display device 142, in other implementations, the system 100 may not include the source device 102, the display device 142, or both.

The source device 102 may include a video capture device (such as a camera, a video camera, a camera phone, a video phone, or the like), a video archive containing stored video, a video server or content provider providing video data, a video feed interface receiving video from a video server or content provider, a computer graphics system for generating computer graphics video data, any other suitable video source, or a combination of such sources of video data. The source device 102 may be integrated with or may be external to the encoder device 110.

The source device 102 is configured to generate or store image data, such as video data. The image data may include or represent one or more images, such as one or more frames, such as an input image frame 104. In some implementations, the input image frame 104 has a first resolution, such as 8K, and may include film grain. A frame can include a still image that, in some cases, is part of a video—e.g., a series of image frames. In some implementations, an image frame includes multiple sample arrays or channels, such as a luma channel (Y) or a chroma channel (Cr or Cb). A pixel of a frame can refer to one or more of the three components (luma and chroma samples) for a given pixel location in a frame. In other instances, a frame may be monochrome and may only include an array of luma samples, in which case the terms pixel and sample can be used interchangeably.

The encoder device 110 includes a video encoder 112 and an output interface 114. The video encoder 112 is configured to generate first film grain parameters 122 (associated with the first resolution) based on the input image frame 104 (having the first resolution). For example, the video encoder 112 (e.g., a film grain estimator) may generate one or more film grain parameters in accordance with a codec format, such as an AOMedia format (e.g., an AOMedia Video 1 (AV1) format). Referring to an example 190, the one or more film grain parameters may be generated using an autoregressive model for representing a film grain pattern. To illustrate, within a pixel array having a horizontal dimension along an x-axis and a vertical dimension along a y-axis, a template of film grain of an image may be synthesized such that G(x, y) is a zero-mean film grain sample at the position with coordinates (x, y). In some implementations,

$$G ( x , y ) = a 0 G ( x - 2 , y - 2 ) + a 1 G ( x - 1 , y - 2 ) + a 2 G ( x , y - 2 ) + \text{…} + z ,$$

where lags of size 0 to 3 are supported, and where a0, a1, etc. are autoregressive coefficients (e.g., one or more film grain parameters). Additionally, it is noted that G(x+k, y+m) may refer to previous film grain sample values in the causal neighborhood, and z is the unit-variance Gaussian noise. The count of AR-coefficients is determined by the lag parameter L and is equal to 2L(L+1) for luma and 2L(L+1)+1 for chroma component. In chroma components, there is one additional coefficient to capture correlation with a luma grain sample at the same spatial position. Additionally, L=0 corresponds to the case of modeling Gaussian noise whereas higher values of L may correspond to film grain with larger size of grains.

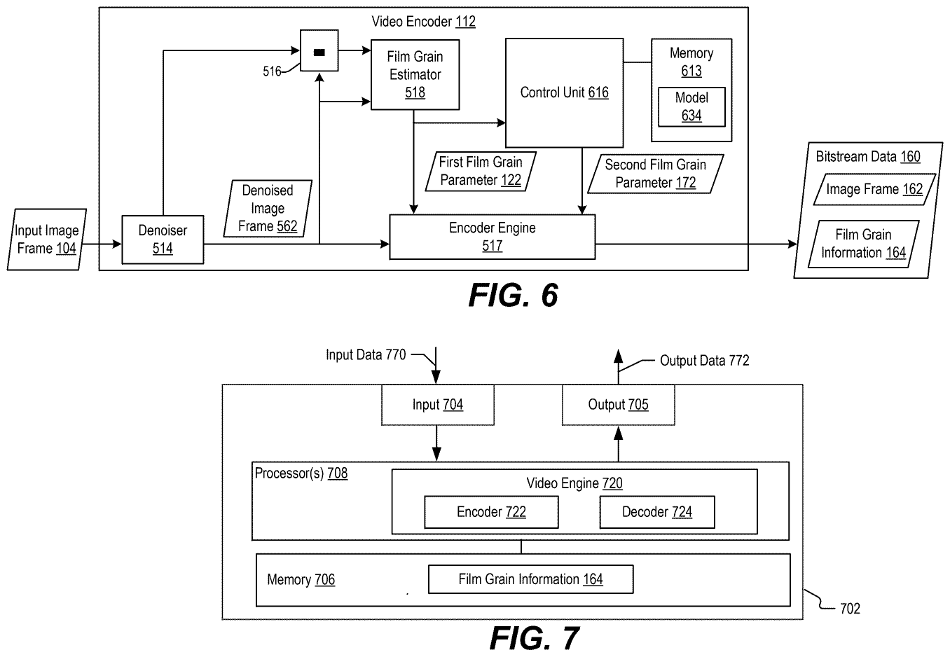

The video encoder 112 is also configured to encode data to generate encoded data. For example, the video encoder 112 encodes the data to generate bitstream data 160—also referred to as an encoded video bitstream, video bitstream, or bitstream. To illustrate, the video encoder 112 may implement a compression technique to encode the input image frame 104 to generate an image frame 162 (e.g., an encoded version of the input image frame 104). Additionally, or alternatively, the bitstream data may include film grain information 164 that includes or indicates the first film grain parameter 122. In some implementations, the film grain information 164 may include an SEI message, such as an SEI message that is encoded by the video encoder 112. It is noted that the video encoder 112 may be able to perform one or more additional operations as described further herein at least with reference to FIG. 5 or 6.

The output interface 114 may include a modulator/demodulator (modem) and/or a transmitter. The output interface 114 may be configured to transmit the bitstream data 160 to the decoder device 130 via a communication link 126. The communication link 126 may include one or more wired networks, one or more wireless networks, or a combination thereof.

The video encoder 112 may transmit the bitstream data 160 (e.g., the encoded video data) to the decoder device 130 via the output interface 114. In other examples, the encoded video data (e.g., the bitstream data 160) may also be stored onto a storage medium or a file server, such as cloud storage, for access by the decoder device 130 decoding and/or playback. In some implementations, the encoder device 110 includes a memory that is configured to store the encoded video data, one or more film grain parameters (e.g., the first film grain parameter 122), or a combination thereof. In some embodiments, the memory includes a buffer or a cache. Additionally, or alternatively, the memory includes or stores instructions. The instructions may be executable by a processor to perform one or more operations described herein. For example, in some embodiments, the encoder device 110 includes one or more processors.

The decoder device 130 includes an input interface 132 and a video decoder 134. The input interface 132 may include a modulator/demodulator (modem) and/or a receiver. The input interface 132 may be configured to receive the bitstream data 160 from the encoder device 110 via the communication link 126. The input interface 132 may provide the received bitstream data 160 to the video decoder 134.

The video decoder 134 is configured to decode the bitstream data 160 to generate a decoded version of the image frame 162 (having the first resolution). The video decoder 134 may downscale the decoded version of the image frame 162 to generate a downscaled image frame having a second resolution.

Additionally, the video decoder 134 is also configured to decode the bitstream data 160 to identify the film grain information 164, such as the first film grain parameter 122 associated with the first resolution. The video decoder 134 may also determine whether the film grain information 164 includes film grain parameters, such as a second film grain parameter 172, that correspond to an output resolution (e.g., a second resolution). For example, the second film grain parameter 172 may have been generated by the video encoder 112 and included in in the film grain information 164. If the film grain information 164 includes the film grain parameters that correspond to the output resolution, the video decoder 134 may select the film grain parameters corresponding to the output resolution. Alternatively, if the film grain information 164 does not include the film grain parameters that correspond to the output resolution, the video decoder 134 may generate the second film grain parameter 172 (associated with the second resolution) based on the first film grain parameter 122 (associated with the first resolution).

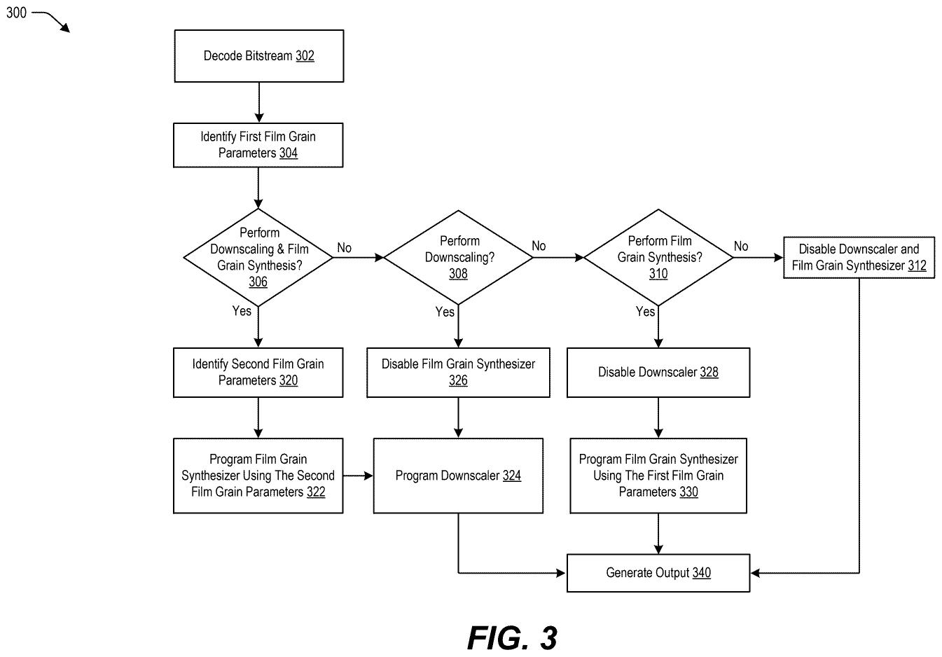

The video decoder 134 may generate film grain data based on the second film grain parameter 172 and add the film grain data to the downscaled image frame to generate the output image frame 180. The decoder device 130 (e.g., the video decoder 134) may provide the output image frame 180 to the display device 142. It is noted that the video decoder 134 may be able to perform one or more additional operations as described further herein at least with reference to FIG. 3.

The display device 142 is configured to display the output image frame 180—e.g., decoded video data. The display device 142 may include a liquid crystal display (LCD), a plasma display, a light emitting diode (LED) display, or another type of display device, as illustrative, non-limiting examples. The display device 142 may be integrated with or may be external to the decoder device 130.

Although the encoder device 110 is described as including the video encoder 112, in other embodiments, the encoder device 110 may also include the video decoder 134. For example, the encoder device 110 may include a video engine that includes the video encoder 112 and the video decoder 134. Accordingly, the video encoder 112 may be configured to perform operations described with reference to the video encoder 112 and operations as described with respect to the video decoder 134. Additionally, or alternatively, although the decoder device 130 is described as including the video decoder 134, in other embodiments, the decoder device 130 may also include the video encoder 112. For example, the decoder device 130 may include a video engine that includes the video encoder 112 and the video decoder 134. Accordingly, the decoder device 130 may be configured to perform operations described with reference to the video encoder 112 and operations as described with respect to the video decoder 134.

The video encoder 112 and the video decoder 134 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. If the techniques herein are implemented partially in software, a device that includes the video encoder 112 and/or the video decoder 134 may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of the video encoder 112 and the video decoder 134 may be included in one or more encoders or decoders, either of which may be integrated as part of a combined encoder/decoder (CODEC) in a respective device.

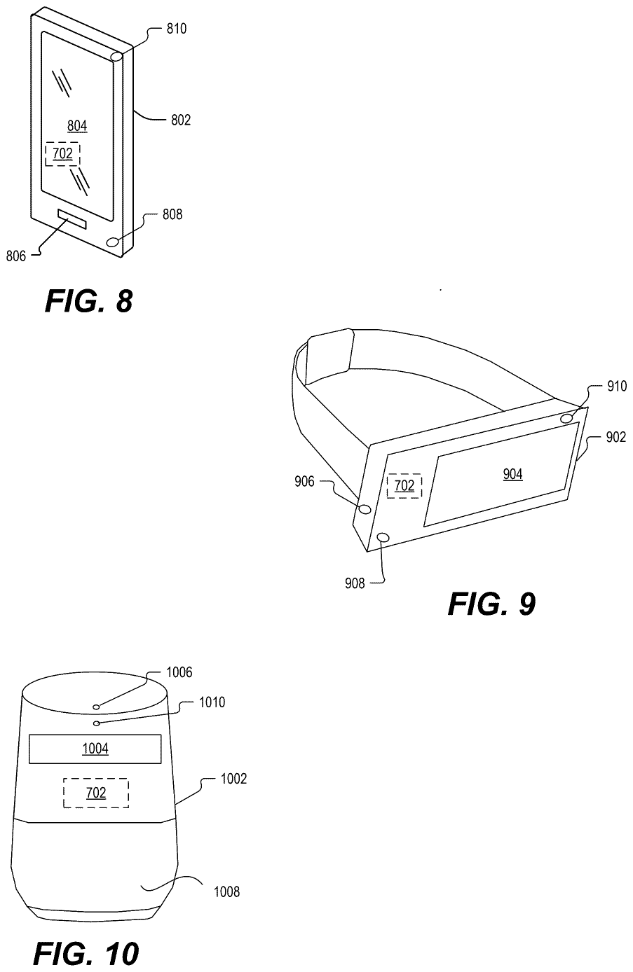

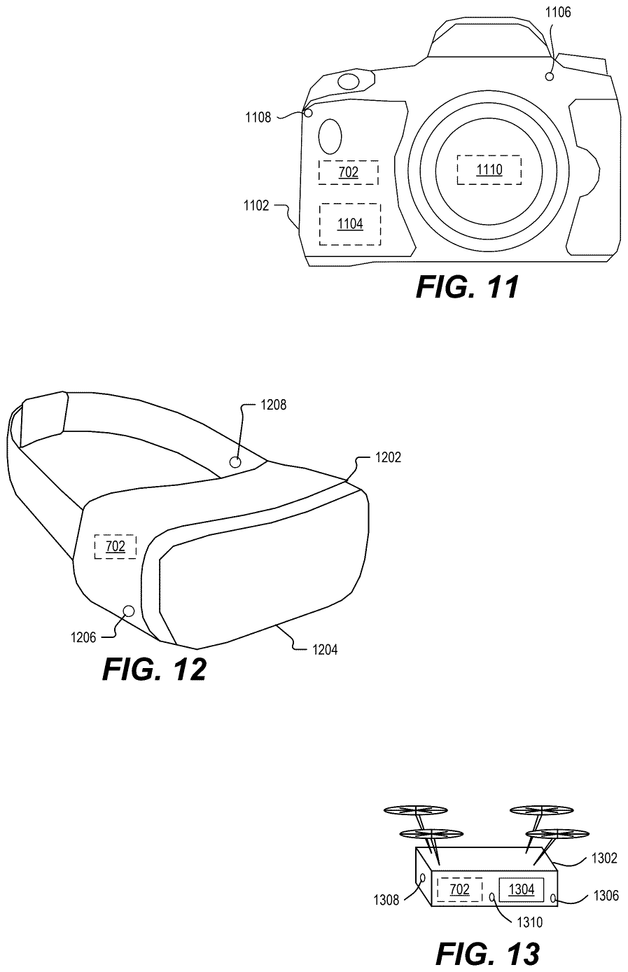

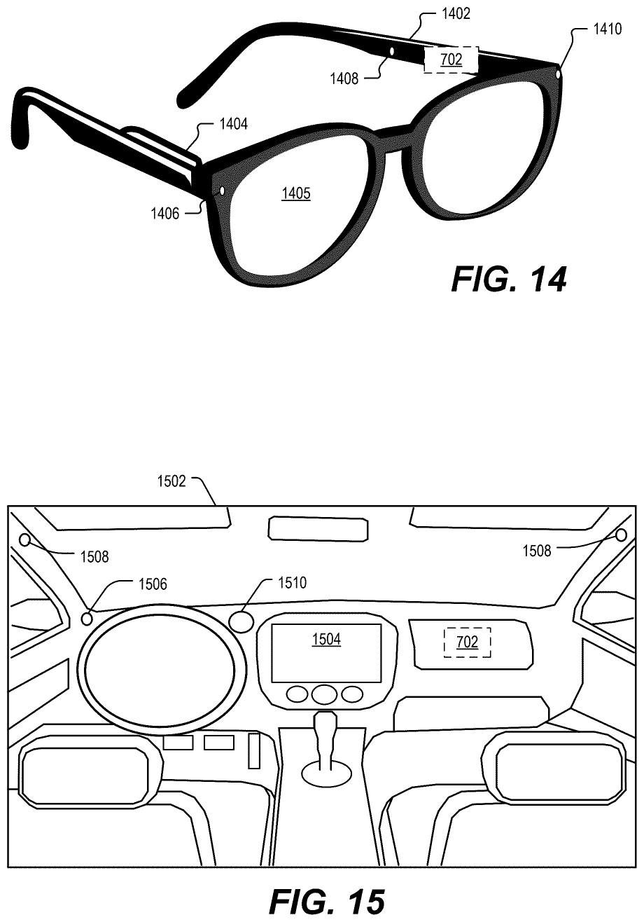

In some examples, the encoder device 110 and/or the decoder device 130 corresponds to or is included in one of various types of devices, such that the video encoder 112 and/or the video decoder 134 can be integrated in multiple types of devices. In an illustrative example, the video encoder 112 and/or the video decoder 134 is integrated in a wearable device, such as a wearable electronic device as depicted in 9, a virtual reality, mixed reality, or augmented reality headset as depicted in FIG. 12, a mixed reality or augmented reality glasses device as described with reference to FIG. 14, or another wearable device. In another illustrative example, the video encoder 112 and/or the video decoder 134 is integrated in a mobile device (a mobile phone or a tablet) as depicted in FIG. 8, a voice-controlled speaker system as depicted in FIG. 10, a camera as depicted in FIG. 11, a vehicle as depicted in FIG. 13 or FIG. 15, a computer or a server, or another system or device.

As described with reference to FIG. 1, the present disclosure provides techniques for supporting film grain synthesis. For example, the video decoder 134 may receive the bitstream data 160 that includes an image frame (e.g., video) that is provided at a higher resolution as compared to an output resolution to be displayed at the display device 142. The video decoder 134 may perform decoding on the bitstream data 160 and may selectively perform downscaling, and/or film grain synthesis to generate the output image frame 180 associated with the output resolution. The video decoder 134 may identify the second film grain parameter 172 (associated with the output resolution) provided in the bitstream data 160, or may generate the second film grain parameter 172 based on the first film grain parameter 122 (associated with the first resolution) and included the bitstream data 160. The identification or generation of the second film grain parameter 172 may enable film grain data to be added to a second image frame having the second resolution (e.g., an output resolution), which may reduce power consumption and improve an image quality of the output image frame 180 as compared performing film grain synthesis on a first image frame (e.g., a decoded version of the image frame 162) and then downscaling the first image frame (having film grain) to generate the output image frame 180.

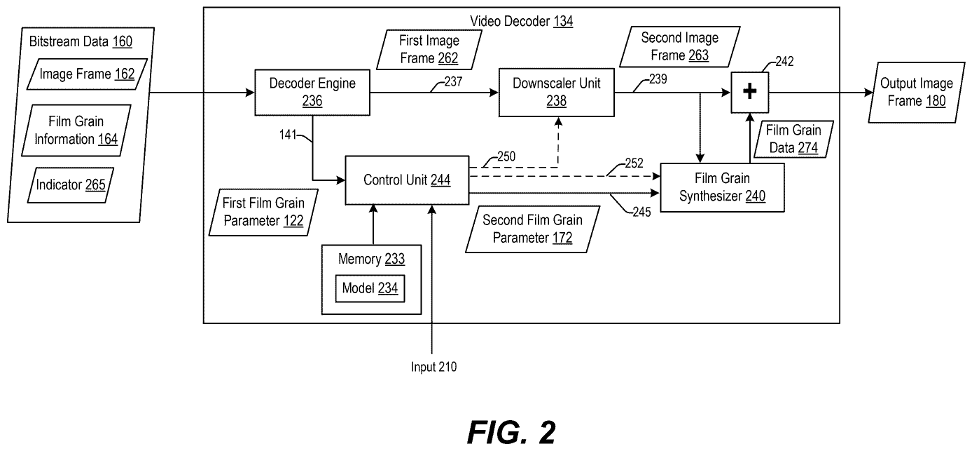

FIG. 2 is a diagram of an example of a video decoder that supports film grain synthesis, in accordance with some aspects of the present disclosure. The video decoder may include or correspond to the video decoder 134. The video decoder 134 includes a decoder engine 236, a downscaler unit 238, a film grain synthesizer 240, an adder 242, and a control unit 244. The video decoder 134 also may include a memory 233. Although the memory 233 is described as being included in the video decoder 134, in other implementations, the memory 233 may be external to the video decoder 134. Optionally, in some embodiments, the components of the video decoder 134 constitute hardware, such as video decoder hardware that includes the one or more processors.

The video decoder 134 is configured to receive the bitstream data 160. For example, the decoder engine 236 of the video decoder 134 may receive the bitstream data 160. The bitstream data 160 may include a representation of one or more image frames (e.g., the image frame 162), the film grain information 164, and one or more indicators (hereinafter referred to as the “indicator 265”). The film grain information 164 may include or indicate the first film grain parameter 122, the second film grain parameter 172, or a combination thereof. The first film grain parameter 122 may include a first set of auto-regressive (AR) coefficients, and the second film grain parameter 172 may include a second set of AR coefficients. Additionally, or alternatively, the film grain information 164 may be in compliance with an AV1 format. For example, the first film grain parameter 122, the second film grain parameter 172, or both, may be in compliance with an AV1 format.

The indicator 265 may include or indicate a film grain indicator, a downscale indicator, or a combination thereof. The film grain indicator may indicate whether film grain was performed on the image frame 162, a lag size associated with a film grain parameter, or a combination thereof. The downscale indicator may indicate a first resolution (associated with the first film grain parameters 122), a second resolution (associated with the second film grain parameter 172), a downscale factor/ratio associated with the first resolution and the second resolution, or a combination thereof.

The decoder engine 236 is configured to perform one or more decoding operations on the bitstream data 160. For example, the decoder engine 236 may perform a decoding operation on the bitstream data 160 to decode the representation (e.g., the image frame 162) to obtain a first image frame 262. The first image frame 262 may have a first resolution. The decoder engine 236 may provide the first image frame 262 to the downscaler unit 238 via a data path 237.

As another example, the decoder engine 236 may perform the decoding operation on the bitstream data 160 to decode the film grain information 164 and to obtain the first film grain parameter 122, the second film grain parameter 172, or a combination thereof. As another example, the decoder engine 236 may perform the decoding operation on the bitstream data 160 to decode the indicator 265 to obtain the film grain indicator, the downscale indicator, or a combination thereof. The decoder engine 236 may provide, via a data path 141, the decoded film grain information 164, the decoded indicator 265, or a combination thereof, to the control unit 244.

The control unit 244 is configured to receive the decoded film grain information 164 (e.g., the first film grain parameter 122 and/or the second film grain parameter 172), the decoded indicator 265, or a combination thereof, from the decoder engine 236. In some implementations, the control unit 244 may determine whether the decoded film grain information 164 includes the first film grain parameter 122, the second film grain parameter 172, or a combination thereof. Additionally, or alternatively, the control unit 244 may receive an input 210 from a user or a display device, such as the display device 142 of FIG. 1. The input 210 may indicate an output resolution of the display device, whether or not an output should include film grain (e.g., film grain data), or a combination thereof. In some implementations, the video decoder 134 (e.g., the decoder device 130 of FIG. 1) may communicate the output resolution of the display device 142 to the encoder device 110 (e.g., the video encoder 112) of FIG. 1 to enable the video encoder 112 to generate the second film grain parameter 172 in accordance with the output resolution of the display device 142.

In some embodiments, the control unit 244 may configure the downscaler unit 238 via a control path 250. For example, the control unit 244 may configure the downscaler unit 238 to be in an active state and perform downscaling, or to be in a disabled state (e.g., a bypassed state) and not perform downscaling. To configure the downscaler unit 238 in the active state, the control unit 244 may indicate, via the control path 250, an input resolution, an output resolution, a downscaling factor/ratio, or a combination thereof, to configure/program the downscaler unit 238 to perform a downscaling operation.

The control unit 244 also may configure the film grain synthesizer 240 via a control path 252. For example, the control unit 244 may configure the film grain synthesizer 240 to be in an active state and perform film grain synthesis, or to be in a disabled state and not perform film grain synthesis (e.g., not generate film grain data 274).

In some implementations, the control unit 244 is configured to select or generate film grain parameters to be used by the film grain synthesizer 240. For example, the control unit 244 may identify the output resolution for the display device 142 based on the input 210. Additionally, or alternatively, the control unit 244 may determine whether the film grain information 164 includes film grain parameters that correspond to the output resolution. If the film grain information 164 includes the film grain parameters that correspond to the output resolution, the control unit 244 may select the film grain parameters and provide the selected film grain parameters to the film grain synthesizer 240. For example, if the output resolution is the first resolution, the control unit 244 may determine that the film grain information 164 includes the first film grain parameter 122 associated with the first resolution, and select the first film grain parameter 122. As another example, if the output resolution is the second resolution, the control unit 244 may determine that the film grain information 164 includes the second film grain parameter 172 associated with the second resolution, and select the second film grain parameter 172. Alternatively, if the output resolution is the second resolution, the control unit 244 may determine that the film grain information 164 does not includes the second film grain parameter 172 associated with the second resolution. Based on a determination that that the film grain information 164 does not include the second film grain parameter 172 associated with the second resolution, the control unit 244 may select the first film grain parameter 122 and generate the second film grain parameter 172 based on the first film grain parameter 122.

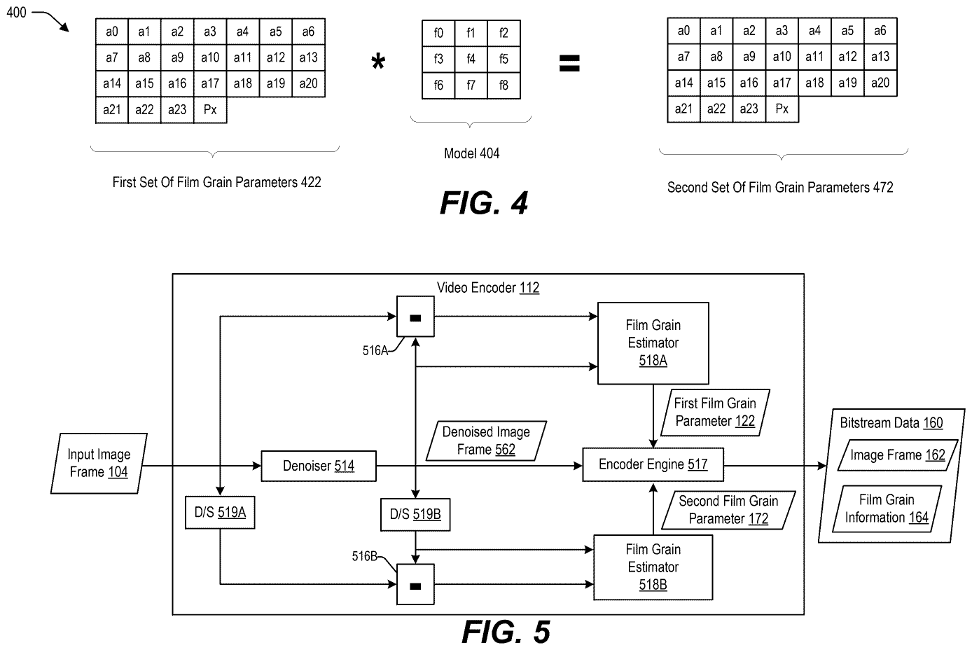

To generate the second film grain parameter 172 based on the first film grain parameter 122, the control unit 244 may select a model 234 from one or more models stored at the memory 233. In some implementations, the control unit 244 may select the model 234 based on a lag of the first film grain parameter 122, the first resolution of the first film grain parameter 122, a second resolution (e.g., the output resolution), or a combination thereof. The model 234 may include a kernel, a linear function, a non-linear function, a neural network, or a combination thereof. In some aspects, the model 234 is trained using a neural network. The control unit 244 may apply the model 234 to the first film grain parameter 122 to generate the second film grain parameter 172. An example of use of a model (e.g., the model 234) to generate a film grain parameter is described further herein at least with reference to FIG. 4.

In some implementations, the film grain information 164 includes multiple film grain parameters are associated with respective resolutions that are each distinct from the output resolution. For example, the output resolution is a third resolution that is different from the first resolution associated with the first film grain parameter 122 and the second resolution associated with the second film grain parameter 172. In such implementations, the control unit 244 may determine whether the film grain information 164 includes film grain parameters associated with the third resolution. If the film grain information 164 does not include film grain parameters associated with the third resolution, the control unit 244 may select the first film grain parameter 122 or the second film grain parameter 172, and an appropriate model from the memory 233, to generate a third film grain parameter associated with the third resolution.

The downscaler unit 238 is configured to receive the first image frame 262 from the decoder engine 236 via a data path 237 and perform a downscaling operation based on the first image frame 262. For example, the downscaler unit 238, when in the active state, may perform the downscaling operation to downscale the first image frame 262 having the first resolution to generate a second image frame 263 having a second resolution (that is a lower resolution than the first resolution). The downscaler unit 238 may output the second image frame 263 via a data path 239. When the downscaler unit 238 is in the disabled state (e.g., a bypass state), the first image frame 262 (having the first resolution) output by the decoder engine 236 via the data path 237 may be provided directly to the data path 239.

The film grain synthesizer 240, when in the active state, is configured to generate film grain data 274. For example, the film grain synthesizer 240 may receive a film grain parameter, such as the first film grain parameter 122 or the second film grain parameter 172, from the control unit 244 via a data path 245, and generate the film grain data 274 based on the received film grain parameter. Additionally, the film grain synthesizer 240 may receive an image frame (e.g., the second image frame 263) output by the downscaler unit 238 and generate the film grain data 274 based on the received image frame. When the film grain synthesizer 240 is configured in the disabled state, the film grain synthesizer 240 may provide no output to the adder 242 or may provide a predetermined value, such as a null set, to the adder 242.

The adder 242 is configured to receive the image frame (e.g., the second image frame 263) output by the downscaler unit 238, and the film grain data 274 output by the film grain synthesizer 240. The adder 242 may add (e.g., combine) the film grain data 274 and the received image frame to generate the output image frame 180. If the adder 242 does not provide an output to the adder 242 or provides the predetermined value (e.g., a null set) to the adder 242, the adder 242 outputs the image frame (e.g., the first image frame 262 or the second image frame 263) received via the data path 239 as the output image frame 180. The output image frame 180 may be provided to a display device (e.g., the display device 142), stored at a memory (e.g., the memory 233 or another memory), or a combination thereof.

During operation of the video decoder 134 is described with reference to FIG. 3. FIG. 3 is a diagram of an example of a method 300 of operation of a video decoder, in accordance with some aspects of the present disclosure. The video decoder may include or correspond to the system 100 or the decoder device 130 of FIG. 1, the video decoder 134 of FIG. 1 or 2, or a combination thereof. In a particular aspect, one or more operations of the method 300 are performed by the system 100, the decoder device 130, the video decoder 134, a processor, or a combination thereof.

At block 302, the video decoder 134 decodes a bitstream. For example, the bitstream may include or correspond to the bitstream data 160. To illustrate, the video decoder 134 may receive the bitstream data 160 and may use the decoder engine 236 to decode the bitstream data 160.

At block 304, the video decoder 134 identifies first film grain parameters (e.g., the first film grain parameter 122). For example, the decoder engine 236 may decode the bitstream data 160 to determine the film grain information 164 that includes or indicates the first film grain parameter 122. In some implementations, the video decoder 134 also may determine or identify whether the film grain information 164 includes or indicates second film grain parameters (e.g., the second film grain parameter 172).

Additionally, or alternatively, the video decoder 134 may determine or identify the indicator 265 (e.g., a downscale indicator, a film grain indicator, or a combination thereof), the input 210, or a combination thereof. The downscale indicator may indicate a first resolution associated with the first film grain parameters (e.g., the first film grain parameter 122), a second resolution associated with the second film grain parameters (e.g., the second film grain parameter 172), a downscaling factor/ratio associated with the first resolution and the second resolution, or a combination thereof. The film grain indicator may indicate whether the film grain synthesis is applied to an image frame, which film grain parameters (associated with the first resolution) should be used for the image frame, a lag value of the film grain parameters, or a combination thereof. The input 210 may indicate an output resolution of a display device (e.g., the display device 142), whether film grain synthesis should be applied to generate the output image frame 180, or a combination thereof. In some implementations, the video decoder 134 (e.g., the control unit 244) may determine downscaling information based on the downscale indicator, the film grain indicator, the input 210, or a combination thereof. For example, the downscaling information may include or indicate whether or not to perform downscaling, the output resolution of the display device, a lag associated with the first film grain parameter 122, or a combination thereof.

At block 306, the video decoder 134 determines whether to perform downscaling and film grain synthesis. For example, the control unit 244 may determine whether to perform downscaling and film grain synthesis. To illustrate, the control unit 244 may determine whether to perform downscaling based on the downscale indicator, the input 210, or a combination thereof. In some embodiments, the control unit 244 may determine a resolution associated with the display device 142 and indicated by the input 210, and may determine a resolution associated with the first image frame 262. If the resolution associated with the display device 142 and the resolution associated with the first image frame 262 are the same, then downscaling does not need to be perform. Alternatively, if the resolution associated with the display device 142 is a lower resolution than the resolution associated with the first image frame 262, then downscaling needs to be performed. As another example, the control unit 244 may determine whether to perform film grain synthesis. To illustrate, the control unit 244 may determine whether to perform downscaling based on the film grain indicator, the input 210, or a combination thereof. If the film grain indicator indicates that film grain synthesis is not applied, or if the input 210 indicates that film grain synthesis not to be applied, then the control unit 244 determines to not perform film grain synthesis. Alternatively, if the film grain indicator indicates that film grain synthesis is applied, or if the input 210 indicates that film grain synthesis is to be applied, then the control unit 244 determines to perform film grain synthesis. If the film grain indicator indicates that film grain synthesis is applied, and the input 210 indicates that film grain synthesis not to be applied, then the control unit 244 determines to not perform film grain synthesis.

If the video decoder 134 determines to perform downscaling and film grain synthesis, the method 300 advances to block 320. Alternatively, if the video decoder 134 determines to not perform downscaling and film grain synthesis, the method advances to block 308. At block 308, the video decoder 134 determines whether to perform downscaling. The determination of whether to perform downscaling at block 308 may correspond to the operations of the video decoder 134 described for block 306 with reference to determining whether to perform downscaling.

If the video decoder 134 determines to perform downscaling, the method 300 advances to block 326. Alternatively, if the video decoder 134 determines to not perform downscaling, the method advances to block 310. At block 310, the video decoder 134 determines whether to perform film grain synthesis. The determination of whether to perform film grain synthesis at block 310 may correspond to the operations of the video decoder 134 described for block 306 with reference to determining whether to perform film grain synthesis.

If the video decoder 134 determines to perform film grain synthesis, the method 300 advances to block 328. Alternatively, if the video decoder 134 determines to not perform film grain synthesis, the method advances to block 312. At block 312, the video decoder 134 disables a downscaler and a film grain synthesizer. For example, the control unit 244 may send, via the control path 250, a control signal to the downscaler unit 238 to disable or bypass the downscaler unit 238. Additionally, the control unit 244 may send, via the control path 252, a control signal to the film grain synthesizer 240 to disable the film grain synthesizer 240. At block 340, the video decoder 134 generates an output based on the configuration of the downscaler unit 238 and/or the film grain synthesizer 240. The output may include or correspond to the output image frame 180. In examples where the downscaler unit 238 and the film grain synthesizer 240 are both disabled, the output image frame 180 may include the first image frame 262 having the first resolution and that does not include film grain data.

Referring to block 320, after the video decoder 134 determines (at block 306) to perform downscaling and film grain synthesis, the video decoder 134 identifies second film grain parameters at block 320. For example, the control unit 244 may determine whether the film grain information 164 received from the decoder engine 236 includes or indicates the second film grain parameters (e.g., the second film grain parameter 172). If the film grain information 164 does not include or indicate the second film grain parameters (associated with an output resolution as indicated by the input 210), the control unit 244 may generate the second film grain parameters (e.g., the second film grain parameter 172) based on the first film grain parameters (e.g., the first film grain parameter 122). In some such implementations, the control unit 244 may select the model 234 from the memory 233 and may apply the model 234 to the first film grain parameters to generate the second film grain parameters.

At block 322, the video decoder 134 programs the film grain synthesizer using the second film grain parameters. For example, the control unit 244 may send, via the data path 245, the second film grain parameter 172 to the film grain synthesizer 240.

At block 324, the video decoder 134 programs the downscaler. For example, the control unit 244 may send, via the control path 250, an indication of the second resolution and/or a downscaling factor/ratio. After the downscaler is programmed at block 324, the method 300 advances to block 340 and the video decoder 134 generates the output (e.g., the output image frame 180). In examples where the downscaler unit 238 and the film grain synthesizer 240 are active, the output image frame 180 may include the second image frame 263 having the second resolution and that includes the film grain data 274.

Referring to block 326, after the video decoder 134 determines (at block 308) to perform downscaling, the video decoder 134 disables the film grain synthesizer at block 326. After the film grain synthesizer is disabled at block 326, the method 300 advances to block 324 and then block 340. In examples where the downscaler unit 238 is active and the film grain synthesizer 240 is disabled, the output image frame 180 may include the second image frame 263 having the second resolution and that does not include film grain data.

Referring to block 328, after the video decoder 134 determines (at block 310) to perform film grain synthesis, the video decoder 134 disables (e.g., bypasses) the downscaler at block 328. At block 330, the video decoder 134 programs the film grain synthesizer using the first film grain parameters. For example, the control unit 244 may send, via the data path 245, the first film grain parameter 122 to the film grain synthesizer 240. After the film grain synthesizer is programmed at block 330, the method 300 advances to block 340. In examples where the downscaler unit 238 is disabled (e.g., bypassed) and the film grain synthesizer 240 is active, the output image frame 180 may include the first image frame 262 having the first resolution and that includes the film grain data 274.

Referring back to FIG. 2, in some embodiments, the video decoder 134 is configured to downscale the first image frame 262 having the first resolution to obtain the second image frame 263 having a second resolution. The video decoder 134 also may be configured to obtain, based on the film grain information 164, the film grain data 274 associated with the second resolution. The video decoder 134 may output the output image frame 180 based on the second image frame 263 and the film grain data 274.

In some embodiments, the video decoder 134 is configured to obtain the first film grain parameter 122 associated with the first resolution. The video decoder 134 may also be configured to apply the model 234 to the first film grain parameter 122 to generate the second film grain parameter 172 associated with the second resolution of the second image frame 263. The second image frame 263 can be based on the first image frame 262—e.g., the second image frame 263 can be a downscaled version of the first image frame 262.

In some examples, the video decoder 134 may be included in a device that corresponds to or is included in one of various types of devices, such that the video decoder 134 can be integrated in multiple types of devices. In an illustrative example, the video decoder 134 is integrated in a wearable device, such as a wearable electronic device as depicted in 9, a virtual reality, mixed reality, or augmented reality headset as depicted in FIG. 12, a mixed reality or augmented reality glasses device as described with reference to FIG. 14, or another wearable device. In another illustrative example, the video decoder 134 is integrated in a mobile device (a mobile phone or a tablet) as depicted in FIG. 8, a voice-controlled speaker system as depicted in FIG. 10, a camera as depicted in FIG. 11, a vehicle as depicted in FIG. 13 or FIG. 15, a computer or a server, or another system or device.

As described with reference to FIGS. 2 and 3, the present disclosure provides techniques for supporting film grain synthesis. For example, the video decoder 134 may receive the bitstream data 160 that includes an image frame (e.g., video) that is provided at a higher resolution as compared to an output resolution to be displayed at a display device. The video decoder 134 may perform decoding on the bitstream data 160 and may selectively perform downscaling, and/or film grain synthesis to generate the output image frame 180 associated with the output resolution. The video decoder 134 may identify the second film grain parameter 172 (associated with the output resolution) provided in the bitstream data 160, or may generate the second film grain parameter 172 based on the first film grain parameter 122 (associated with the first resolution) and included the bitstream data 160. The identification or generation of the second film grain parameter 172 may enable the film grain data 274 to be added to the second image frame 263 having the second resolution, which may reduce power consumption and improve an image quality of the output image frame 180 as compared performing film grain synthesis on the first image frame 262 and then downscaling the first image frame (having film grain) to generate the output image frame 180.

FIG. 4 is a diagram to illustrate an example 400 of generation of film grain parameters, in accordance with some aspects of the present disclosure. Operations described with reference to the example 400 may be performed by the video decoder 134, such as the control unit 244. It is also noted that the operations described with reference to the example 400 may be performed by the video encoder 112 as described with reference to FIG. 6.

As shown, the example includes a first set of film grain parameters 422, a model 404, and a second set of film grain parameters 472. The first set of film grain parameters 422, the model 404, and the second set of film grain parameters 472 may include or correspond to the first film grain parameter 122, the model 234, and the second film grain parameter 172, respectively.

The first set of film grain parameters 422 may be associated with or correspond to a lag value. Additionally, or alternatively, the first set of film grain parameters may be associated with or correspond to a channel, such as a luma channel (Y) or a chroma channel (Cr or Cb).

The model 404 may include a kernel, a linear function, a non-linear function, or a model trained using a neural network. In some implementations, the model 404 includes a kernel that has a dimension of 3×3, or 5×5 or 7×7. The model 404 (e.g., the kernel) may be trained offline and the values (e.g., kernel values) of the model 404 may be adapted to a lag size, an input resolution, an output resolution, a downscale factor/ratio, or a combination thereof.

The first set of film grain parameters 422 cannot be used/applied at a downscaled resolution due to the synthesized grain size. Accordingly, the AR coefficients of the first set of film grain parameters 422 need to be updated for the downscaled resolution such the auto-regressive process generates grain resembling the initial creative intent for the downscaled resolution. To update the AR coefficients for the downscaled resolution, the model 404 may be applied to the first set of film grain parameters 422 to filter the AR coefficients of the first set of film grain parameters 422 to generate the second film grain parameter 172.

FIG. 5 is a diagram of an example of a video encoder that supports generation of film grain parameters, in accordance with some aspects of the present disclosure. The video encoder may include or correspond to the video encoder 112.

The video encoder 112 includes a denoiser 514, a subtractor 516, an encoder engine 517, and a film grain estimator 518. The video encoder 112 also may include a downscaler 519. In some implementations, the video encoder 112 includes video encoder hardware. The video encoder hardware may include the one or more processors, such as one or more processors configured to perform operations as described with reference to the denoiser 514, the subtractor 516, the encoder engine 517, the film grain estimator 518, the downscaler 519, or a combination thereof.

The video encoder 112 is configured to receive image data, such as the input image frame 104. The input image frame 104 may be received from a source device, such as the source device 102 of FIG. 1. In some embodiments, the input image frame 104 has a first resolution and includes film grain.

The denoiser 514 is configured to receive the input image frame 104 and to perform a denoising operation. To illustrate, the denoiser 514 may perform the denoising operation on the input image frame 104 to generate a denoised image frame 562. The input image frame 104 and the denoised image frame 562 may be associated with or have the first resolution, such as an 8k resolution.

The subtractor 516A is configured to receive the input image frame 104 and the denoised image frame 562. The subtractor 516A may generate a residual based on a difference between the input image frame 104 and the denoised image frame 562. For example, the residual may be associated with or represent noise removed by the denoiser 514 from the input image frame 104.

The film grain estimator 518A is configured to receive the denoised image frame 562 from the denoiser 514 and the residual from the subtractor 516A. The film grain estimator 518A may perform a film grain parameter generation operation to generate the first film grain parameter 122. For example, the film grain estimator 518A may perform a film grain parameter generation operation based on the denoised image frame 562 and the residual from the subtractor 516A.

The downscaler 519 is configured to perform a downscaling operation on an image frame and to generate a downscaled version of the image frame. For example, the downscaler 519 may receive an image frame having the first resolution and may perform the downscaling operation to generate a downscaled image frame having the second resolution. To illustrate, the downscaler 519A and the downscaler 519B may receive the input image frame 104 and the denoised image frame 562, respectively. The downscaler 519A may perform the downscaling operation on the input image frame 104 having the first resolution to generate a downscaled input image frame having the second resolution. Additionally, the downscaler 519B may perform the downscaling operation on the denoised image frame 562 having the first resolution to generate a downscaled denoised image frame having the second resolution.

The subtractor 516B is configured to receive the downscaled input image from the downscaler 519A and the downscaled denoised image frame from the downscaler 519B. The subtractor 516B may generate a residual based on a difference between the downscaled input image frame and the downscaled denoised image frame.

The film grain estimator 518B is configured to receive the downscaled denoised image frame from the downscaler 519B and the residual from the subtractor 516B. The film grain estimator 518B may perform a film grain parameter generation operation to generate the second film grain parameter 172. For example, the film grain estimator 518B may perform a film grain parameter generation operation based on the downscaled denoised image frame and the residual from the subtractor 516B.

The encoder engine 517 is configured to perform one or more encoding operations to generate the bitstream data 160. For example, the encoder engine 517 may perform an encoding operation on the denoised image frame 562 to generate an encoded image frame (e.g., the image frame 162). The encoded image frame may include a representation of the denoised image frame 562. The encoder engine 517 may also encode the first film grain parameter 122, the second film grain parameter 172, or a combination thereof to generate the film grain information 164. In some implementations, the encoder engine 517 may also generate or encode one or more indicators to be included in the bitstream data 160 as the indicator 265.

Although the video encoder 112 is described as including the downscaler 519, the subtractor 516B, and the film grain estimator 518B, in other implementations, the video encoder 112 may not include the downscaler 519, the subtractor 516B, and the film grain estimator 518B. Additionally, or alternatively, the video encoder 112 may include one or more other components, such as a memory. The memory may be configured to store film grain parameters, such as the first film grain parameter 122, the second film grain parameter 172, or a combination thereof.

FIG. 6 is a diagram of an example of a video encoder that supports generation of film grain parameters, in accordance with some aspects of the present disclosure. The video encoder may include or correspond to the video encoder 112.

The video encoder 112 includes a denoiser 514, a subtractor 516, an encoder engine 517, and a film grain estimator 518. Additionally, the video encoder 112 includes a control unit 616 and a memory 613. The memory 613 may include or be configured to store a model 634. The memory 613 and the model 634 may include or correspond to the memory 233 and the model 234 of FIG. 2. The control unit 616 may include or correspond to the control unit 244 of FIG. 2. In some implementations, the video encoder 112 includes video encoder hardware. The video encoder hardware may include the one or more processors, such as one or more processors configured to perform operations as described with reference to the denoiser 514, the subtractor 516, the encoder engine 517, the film grain estimator 518, the control unit 616, or a combination thereof.

The denoiser 514, the subtractor 516, the encoder engine 517, and the film grain estimator 518 may be configured to perform one or more operations as described with reference to the video encoder 112 of FIG. 5. Additionally, the control unit 616 may receive the first film grain parameter 122 from the film grain estimator 518 and generate the second film grain parameter 172 based on the first film grain parameter 122. To generate the second film grain parameter 172, the control unit 616 may select a model 634 from one or more models stored at the memory 613. In some implementations, the control unit 616 may select the model 634 based on a lag of the first film grain parameter 122, the first resolution of the first film grain parameter 122, a second resolution (e.g., the output resolution indicated by the video decoder 134), or a combination thereof. The model 634 may include a kernel, a linear function, a non-linear function, or a model trained using a neural network. The control unit 616 may apply the model 634 to the first film grain parameter 122 to generate the second film grain parameter 172.

Referring to FIGS. 5 and 6, in some embodiments, the video encoder 112 is configured to generate a representation (e.g., the image frame 162) of an input image frame 104 having a first resolution. The video encoder 112 is also configured to generate the film grain information 164 that indicates the first film grain parameter 122 associated with the first resolution and the second film grain parameter 172 associated with a second resolution that is different from the first resolution. The video encoder 112 is configured to output, to the decoder (e.g., the decoder device 130, the video decoder 134, or the decoder engine 236), output data (e.g., the bitstream data 160) that includes and the representation (e.g., the image frame 162) of the input image frame 104 and the film grain information 164.

In some embodiments, the video encoder 112 is configured to obtain the first film grain parameter 122 associated with the first resolution. The video encoder 112 may also be configured to apply the model 634 to the first film grain parameter 122 to generate the second film grain parameter 172 associated with the second resolution of a second image frame (e.g., the second image frame 263). The second image frame can be based on a first image frame (e.g., the first image frame 262)—e.g., the second image frame can be a downscaled version of the first image frame.

In some examples, the video encoder 112 may be included in a device that corresponds to or is included in one of various types of devices, such that the video encoder 112 can be integrated in multiple types of devices. In an illustrative example, the video encoder 112 is integrated in a wearable device, such as a wearable electronic device as depicted in 9, a virtual reality, mixed reality, or augmented reality headset as depicted in FIG. 12, a mixed reality or augmented reality glasses device as described with reference to FIG. 14, or another wearable device. In another illustrative example, the video encoder 112 is integrated in a mobile device (a mobile phone or a tablet) as depicted in FIG. 8, a voice-controlled speaker system as depicted in FIG. 10, a camera as depicted in FIG. 11, a vehicle as depicted in FIG. 13 or FIG. 15, a computer or a server, or another system or device.

As described with reference to FIGS. 5 and 6, the present disclosure provides techniques for supporting film grain synthesis. For example, the video encoder 112 may generate the bitstream data 160 that includes an image frame (e.g., video). The video encoder 112 also may generate the film grain information 164 that includes the first film grain parameter 122 (associated with the first resolution) and the second film grain parameter 172 (associated with the second resolution). Generating the film grain information 164 that includes or indicates the first film grain parameter 122 (associated with the first resolution) and the second film grain parameter 172 (associated with the second resolution) by the video encoder 112 may enable a decoder device (e.g., the decoder device 130) to reduce power consumption and improve an image quality of an output image frame generated by the decoder device.

FIG. 7 depicts a diagram of an example of an integrated circuit 702 operable to support film grain synthesis, in accordance with some examples of the present disclosure. The integrated circuit 702 includes one or more processors 708 (herein after referred to as the “processor 708”) and a memory 706. The processor 708 may include the video engine 720. The video engine 720 includes the encoder 722 and the decoder 724. The encoder may include or correspond to the encoder device 110, the video encoder 112, the encoder engine 517, or a combination thereof. The decoder 724 may include or correspond to the decoder device 130, the video decoder 134, the decoder engine 236, or a combination thereof. The memory 706 includes (e.g., stores) the film grain information 164, which may include or indicate the first film grain parameter 122, the second film grain parameter 172, or a combination thereof. Additionally, or alternatively, the memory 706 may store one or more models, such as the model 234 or 634.

The integrated circuit 702 also includes an input 704, such as one or more bus interfaces, to enable the integrated circuit 702 to receive signals representing input data 770 for processing. For example, the input data 770 can correspond to or include the input image frame 104, the bitstream data 160, the image frame 162, the film grain information 164, the indicator 265, the input 210, or a combination thereof.

The integrated circuit 702 also includes an output 705, such as a bus interface, to enable the integrated circuit 702 to output signals representing output data 772. For example, the output data 772 can correspond to or include the bitstream data 160, the image frame 162, the film grain information 164, the output image frame 180, the indicator 265, or a combination thereof.

The integrated circuit 702 including the video engine 720 and the film grain information 164 enables implementation of film grain synthesis. For example, the system or the device may include a mobile device (e.g., a mobile phone or tablet) as depicted in FIG. 8, a wearable electronic device as depicted in FIG. 9, a voice-controlled speaker system as depicted in FIG. 10, a camera as depicted in FIG. 11, a virtual reality, mixed reality, or augmented reality headset as depicted in FIG. 12, a mixed reality or augmented reality glasses device, as described with reference to FIG. 14, or a vehicle as depicted in FIG. 13 or FIG. 15.

In some embodiments, the system or the device that includes the integrated circuit 702 also includes or is coupled to an image sensor (e.g., a camera), an input device (e.g., a microphone, a keyboard or touch screen, a etc.), a display device, a speaker, a modem, or a combination thereof. For example, the image sensor and the display device may include or correspond to the source device 102 and the display device 142, respectively.

In some embodiments, the system or the device that includes the integrated circuit 702 is operable to support film grain synthesis. For example, the integrated circuit 702 may receive image data, such as the input image frame 104, and generate bitstream data, such as the bitstream data 160. The image data may be received from an image sensor (e.g., the source device 102). The bitstream data may be generated by the video engine 720 (e.g., the encoder 722). The bitstream data 160 may include the image frame 162, the film grain information 164 (e.g., the first film grain parameter 122, the second film grain parameter 172, or both), or a combination thereof. As another example, the integrated circuit 702 (e.g., the decoder 724) may downscale an image having a first resolution to obtain a second image having a second resolution. The integrated circuit 702 (e.g., the decoder 724) may also obtain film grain data, and to output an output image frame based on the second image and the film grain data. The film grain data and the output image may include or correspond to the film grain data 274 and the output image frame 180, respectively. The output image frame may be output to a display device, such as the display device 142.

FIG. 8 depicts a diagram of a mobile device 802 operable to support film grain synthesis, in accordance with some examples of the present disclosure. The mobile device 802 may include or correspond to a phone or a tablet, as illustrative, non-limiting examples. The mobile device 802 includes a display 804 (e.g., a display screen), a microphone 806, a speaker 808, a camera 810 (e.g., an image sensor), and the integrated circuit 702. Components of the integrated circuit 702, including the video engine 720 (e.g., the encoder 722 and/or the decoder 724), are integrated in the mobile device 802 and are illustrated using dashed lines to indicate internal components that are not generally visible to a user of the mobile device 802.

In some embodiments, the integrated circuit 702 is operable to obtain image data from the camera 810 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 804. Thus, the integrated circuit 702 enables the mobile device 802 to perform encoding operations and/or decoding operations that support film grain synthesis.

FIG. 9 depicts a diagram of a wearable electronic device 902 operable to support film grain synthesis, in accordance with some examples of the present disclosure. The wearable electronic device 902 may include or correspond to a “smart watch,” as an illustrative, non-limiting example. The wearable electronic device 902 includes a display 904 (e.g., a display screen), a microphone 906, a speaker 908, a camera 910 (e.g., an image sensor), and the integrated circuit 702. Components of the integrated circuit 702, including the video engine 720 (e.g., the encoder 722 and/or the decoder 724), is integrated in the wearable electronic device 902 and are illustrated using dashed lines to indicate internal components that are not generally visible to a user of the wearable electronic device 902.

In some embodiments, the integrated circuit 702 is operable to obtain image data from the camera 910 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 904. Thus, the integrated circuit 702 enables the wearable electronic device 902 to perform encoding operations and/or decoding operations that support film grain synthesis.

FIG. 10 is a diagram of a voice-controlled speaker system 1002 operable to support film grain synthesis, in accordance with some examples of the present disclosure. The voice-controlled speaker system 1002 may include or correspond to a wireless speaker and voice activated device, as an illustrative, non-limiting example. The voice-controlled speaker system 1002 can have wireless network connectivity and is configured to execute an assistant operation. The wireless speaker and voice activated device 1002 includes a display 1004 (e.g., a display screen), a microphone 1006, a speaker 1008, a camera 1010 (e.g., an image sensor), and the integrated circuit 702. Components of the integrated circuit 702, including the video engine 720 (e.g., the encoder 722 and/or the decoder 724), are integrated in the voice-controlled speaker system 1002 and are illustrated using dashed lines to indicate internal components that are not generally visible to a user of the voice-controlled speaker system 1002.

In some embodiments, the integrated circuit 702 is operable to obtain image data from the camera 1010 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 1004. Thus, the integrated circuit 702 enables the wireless speaker and voice activated device 1002 to perform encoding operations and/or decoding operations that support film grain synthesis.

FIG. 11 is a diagram of a camera device 1102 operable to support film grain synthesis, in accordance with some examples of the present disclosure. The camera device 1102 includes a display 1104 (e.g., a display screen), a microphone 1106, a speaker 1108, a camera 1110 (e.g., an image sensor), and the integrated circuit 702. Components of the integrated circuit 702, including the video engine 720 (e.g., the encoder 722 and/or the decoder 724) are integrated in the camera device 1102 and are illustrated using dashed lines to indicate internal components that are not generally visible to a user of the camera device 1102.

In some embodiments, the integrated circuit 702 is operable to obtain image data from the camera 1110 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 1104. Thus, the integrated circuit 702 enables the camera device 1102 to perform encoding operations and/or decoding operations that support film grain synthesis.

FIG. 12 is a diagram of a headset 1202, such as a virtual reality, mixed reality, or augmented reality headset, operable to support film grain synthesis, in accordance with some examples of the present disclosure. A visual interface device is positioned in front of the user's eyes to enable display of augmented reality, mixed reality, or virtual reality images or scenes to the user while the headset 1202 is worn. The headset 1202 also includes a display 1204 (e.g., a display screen), a microphone 1206, a speaker 1208, and the integrated circuit 702. Components of the integrated circuit 702, including the video engine 720 (e.g., the encoder 722 and/or the decoder 724), are integrated in the headset 1202 and are illustrated using dashed lines to indicate internal components that are not generally visible to a user of the headset 1202.

In some embodiments, the integrated circuit 702 is operable to obtain image data and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 1204. Thus, the integrated circuit 702 enables the headset 1202 to perform encoding operations and/or decoding operations that support film grain synthesis.

FIG. 13 is a diagram of a first example of a vehicle 1302 operable to support film grain synthesis, in accordance with some examples of the present disclosure. The vehicle 1302 may include or correspond to a manned or unmanned aerial device (e.g., a package delivery drone). The vehicle 1302 includes a display 1304 (e.g., a display screen), a microphone 1306, a speaker 1308, a camera 1310 (e.g., an image sensor), and the integrated circuit 702. Components of the integrated circuit 702, including the video engine 720 (e.g., the encoder 722 and/or the decoder 724), are integrated in the vehicle 1302 and are illustrated using dashed lines to indicate internal components that are not generally visible to a user of the vehicle 1302.

In some embodiments, the integrated circuit 702 is operable to obtain image data from the camera 1310 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 1304. Thus, the integrated circuit 702 enables the vehicle 1302 to perform encoding operations and/or decoding operations that support film grain synthesis.

FIG. 14 is a diagram of a mixed reality or augmented reality glasses device 1402 operable to support film grain synthesis, in accordance with some examples of the present disclosure. The glasses 1402 include a holographic projection unit 1404 configured to project visual data onto a surface of a lens 1405 or to reflect the visual data off of a surface of the lens 1405 and onto the wearer's retina. The glasses 1402 also include a microphone 1406, a speaker 1408, a camera 1410 (e.g., an image sensor), and the integrated circuit 702. Components of the integrated circuit 702, including the video engine 720 (e.g., the encoder 722 and/or the decoder 724), are integrated in the glasses 1402 and are illustrated using dashed lines to indicate internal components that are not generally visible to a user of the glasses 1402.

In some embodiments, the integrated circuit 702 is operable to obtain image data from the camera 1410 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the holographic projection unit 1404. Thus, the integrated circuit 702 enables the glasses 1402 to perform encoding operations and/or decoding operations that support film grain synthesis.

FIG. 15 is a diagram of a second example of a vehicle 1502 operable to support film grain synthesis, in accordance with some examples of the present disclosure. The vehicle 1502 may include or correspond to a car. The vehicle 1502 includes a display 1504 (e.g., a display screen), a microphone 1506, one or more speakers 1508, a camera 1510 (e.g., an image sensor), and the integrated circuit 702. Components of the integrated circuit 702, including the video engine 720 (e.g., the encoder 722 and/or the decoder 724), are integrated in the vehicle 1502 and are illustrated using dashed lines to indicate internal components that are not generally visible to a user of the vehicle 1502.

In some embodiments, the integrated circuit 702 is operable to obtain image data from the camera 1510 and to generate, based on the image data associated with a first image having a first resolution, film grain information (e.g., the film grain information 164). Additionally, or alternatively, the integrated circuit 702 is operable to downscale an image having a first resolution to obtain a second image having a second resolution. The integrated circuit 702 (e.g., the decoder 724) may also obtain film grain data based on the film grain information, and output an output image frame based on the second image and the film grain data. For example, the output image frame may be output to the display 1504. Thus, the integrated circuit 702 enables the vehicle 1502 to perform encoding operations and/or decoding operations that support film grain synthesis.

The embodiments of the systems or devices as described with reference to FIGS. 8-15 are described, respectively, as including a display, a microphone, a speaker, a camera, or a combination thereof. It is noted that in other embodiments of the systems or devices of FIGS. 8-15, one or more of the systems or devices of FIGS. 8-15 may not include the display, the microphone, the speaker, the camera, or a combination thereof. Additionally, or alternatively, one or more of the systems or devices of FIGS. 8-15 may include an additional component. For example, the additional component may include a modem.

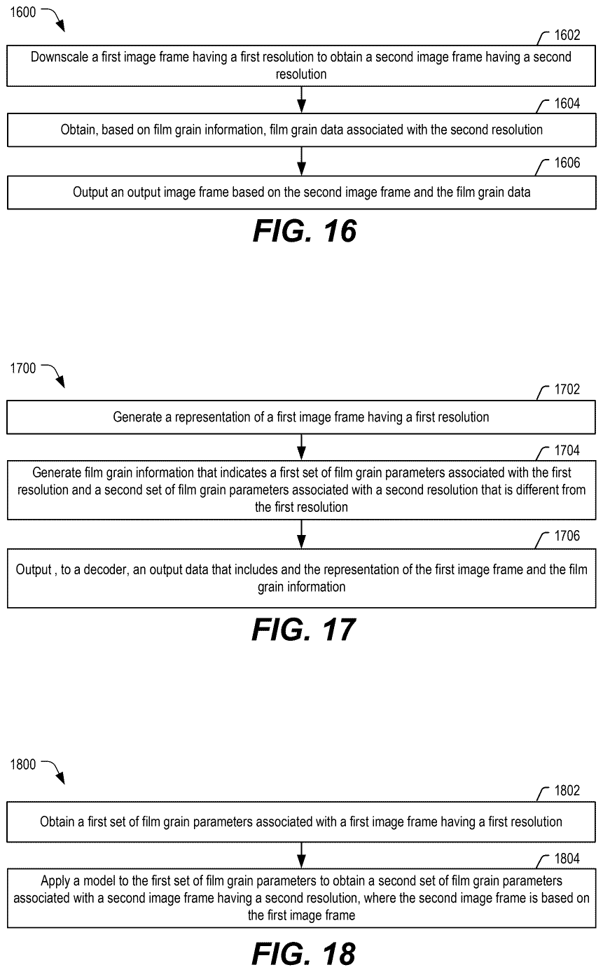

Referring to FIG. 16, FIG. 16 is a diagram of an example of a method 1600 of film grain synthesis, in accordance with some aspects of the present disclosure. In a particular aspect, one or more operations of the method 1600 are performed by the system 100, the decoder device 130, the video decoder 134, the integrated circuit 702, the processor 708, the video engine 720, the decoder 724, a processor, or a combination thereof.

In some embodiments, the method 1600 includes, at block 1602, downscaling a first image frame having a first resolution to obtain a second image frame having a second resolution. Accordingly, the second image frame can be based on the first image frame. For example, the first image frame and the second image frame may include or correspond to the first image frame 262 and the second image frame 263, respectively. The first resolution may be a higher resolution than the second resolution. Additionally, or alternatively, the downscaling may be performed by the downscaler unit 238.

The method 1600 also includes, at block 1604, obtaining, based on film grain information, film grain data associated with the second resolution. For example, the film grain information may include or correspond to the film grain information 164, the first film grain parameter 122, the second film grain parameter 172, the first set of film grain parameters 422, the second set of film grain parameters 472, or a combination thereof. The film grain information may be in compliance with an AV1 format. Additionally, or alternatively, the film grain data may include or correspond to the film grain data 274. The film grain data may be obtained by the film grain synthesizer 240 or the adder 242.

The method 1600 further includes, at block 1606, outputting an output image frame based on the second image frame and the film grain data. For example, the output image frame may include or correspond to the output image frame 180. The output image frame may be output by the decoder device, the video decoder 134, or the adder 242. In some embodiments, the method 1600 includes adding the film grain data to the second image frame to obtain the output image frame. For example, the adder 242 may add the film grain data 274 and the second image frame 263 to generate the output image frame 180.

In some embodiments, the method 1600 includes obtaining, from an encoder, a bitstream that includes a representation of one or more image frames. For example, the bitstream and the one or more image frames may include or correspond to the bitstream data 160 and the image frame 162, respectively. The encoder may include or correspond to the encoder device 110, the video encoder 112, or the encoder engine 517. In some embodiments, the method 1600 includes receiving, via a modem, the bitstream for playout of the output image frame. For example, the decoder device 130 or the video decoder 134 may include a modem.

In some embodiments, the method 1600 may also include decoding the bitstream to obtain the first image frame having the first resolution. For example, the decoder engine 236 may decode the bitstream data 160 to generate the first image frame 262. Additionally, or alternatively, the method 1600 may include obtaining, based on the bitstream, a downscale indicator, a film grain indicator, or a combination thereof. The downscale indicator and/or the film grain indicator may include or correspond to the indicator 265.

In some embodiments, the method 1600 includes obtaining, from the encoder, a first set of film grain parameters associated with the first resolution. For example, the first set of film grain parameters may include or correspond to the film grain information 164, the first film grain parameter 122, or the first set of film grain parameters 422. The first set of film grain parameters may be included in the bitstream data 160. The method 1600 may also include applying a model to the first set of film grain parameters to generate a second set of film grain parameters associated with the second resolution of a second image frame. For example, the control unit 244 may apply the model 234 to the first film grain parameter 122 to generate the second film grain parameter 172. The film grain data may be obtained based on the second set of film grain parameters. For example, the film grain synthesizer 240 may generate the film grain data 274 based on the second film grain parameter 172.

In some embodiments, the method 1600 includes obtaining, based on the bitstream, a second set of film grain parameters associated with the second resolution. For example, the second set of film grain parameters may include or correspond to the second film grain parameter 172 or the second set of film grain parameters 472. The film grain data may be based on the second set of film grain parameters. For example, the film grain synthesizer 240 may generate the film grain data 274 based on the second film grain parameter 172.

In some embodiments, the method 1600 includes displaying, via a display device, the output image frame. For example, the display device may include or correspond to the display device 142. The display device may be included in a vehicle. Additionally, or alternatively, the output image frame may be output by a mobile phone, a tablet computer device, a wearable electronic device, a virtual reality headset, a mixed reality headset, or an augmented reality headset.

Referring to FIG. 17, FIG. 17 is a diagram of an example of a method 1700 of film grain parameter generation, in accordance with some aspects of the present disclosure. In a particular aspect, one or more operations of the method 1700 are performed by the system 100, the encoder device 110, the video encoder 112, the integrated circuit 702, the processor 708, the video engine 720, the encoder 722, a processor, or a combination thereof.

In some embodiments, the method 1700 includes, at block 1702, generating a representation of a first image frame having a first resolution. For example, the first frame and the representation may include or correspond to the denoised image frame 562 and the image frame 162, respectively. To illustrate, the video encoder 112 (e.g., the encoder engine 517 may generate the image frame 162 as a representation of the denoised image frame 562.

The method 1700 also includes, at block 1704, generating film grain information that indicates a first set of film grain parameters associated with the first resolution and a second set of film grain parameters associated with a second resolution that is different from the first resolution. The first resolution may be a higher resolution than the second resolution. For example, the film grain information may include or correspond to the film grain information 164. The film grain information may be in compliance with an AV1 format. Additionally, the first set of film grain parameters and the second set of film grain parameters includes or corresponds to the first film grain parameter 122 or the first set of film grain parameters 422, and the second film grain parameter 172 or the second set of film grain parameters 472, respectively. In some embodiments, the encoder engine 517 may generate the film grain information 164 based on the first film grain parameter 122 from the film grain estimator 518A and based on the second film grain parameter 172 from the film grain estimator 518B or the control unit 616.

The method 1700 further includes, at block 1706, outputting, to a decoder, an output data that includes and the representation of the first image frame and the film grain information. For example, the output data may include or correspond to the bitstream data 160. The decoder may include or correspond to the decoder device 130, the input interface 132, the video decoder 134, or the decoder engine 236. In some embodiments, the method 1700 includes transmitting, to the decoder via a modem, a bitstream that includes the output data. The modem may include or correspond to the output interface 114 or the input interface 132. The bitstream may include or correspond to the bitstream data 160.

In some embodiments, the method 1700 includes obtaining a second image frame having the first resolution. For example, the second image frame may include or correspond to the input image frame 104. In some examples, the method 1700 includes generating, at one or more cameras, image data that includes the second image frame. For example, the one or more cameras may include or correspond to the source device 102. The method 1700 also may include performing a denoise operation on the second image frame to obtain the first image frame having the first resolution. For example, the denoiser 514 may perform the denoise operation on the input image frame 104 to generate the denoised image frame 562. The method 1700 may include obtaining first residual information based on the first image frame and the second image frame. To illustrate, the subtractor 516A of FIG. 5 or the subtractor 516 of FIG. 1 or 6, respectively, may generate residual information based on the input image frame 104 and the denoised image frame 562. The first residual information may be associated with the first resolution. In some examples, the method 1700 includes obtaining, based on the first image frame and the first residual information, the first set of film grain parameters associated with the first resolution. For example, the film grain estimator 518A or the film grain estimator 518 of FIG. 1 or 6, respectively, may generate the first film grain parameter 122.

In some embodiments, the method 1700 includes obtaining, based on the first image frame, a third image frame having the second resolution. For example, the third image frame may include or correspond to a downscaled version of the denoised image frame 562. To illustrate, the downscaled version of the denoised image frame 562 may be output by the downscaler 519B. Additionally, in some examples, the method 1700 may include obtaining, based on the second image frame, a fourth image frame having the second resolution. For example, the fourth image may include or correspond to a downscaled version of the input image frame 104. To illustrate, the downscaled version of the input image frame 104 may be output by the downscaler 519A. The method 1700 may also include obtaining, based on the fourth image, the second set of film grain parameters associated with the second resolution. For example, the film grain estimator 518B of FIG. 5 may generate the second film grain parameter 172 based on the downscaled version of the denoised image frame 562. In some such examples, the method 1700 includes obtaining second residual information based on the third image frame and the fourth image frame. To illustrate, the subtractor 516B of FIG. 5 may generate the second residual information based on downscaled version of the input image frame 104 and the downscaled version of the denoised image frame 562. The second residual information may be associated with the second resolution, and the second set of film grain parameters may be based on the second residual information.

In some embodiments, the method 1700 includes obtaining the first set of film grain parameters associated with the first resolution. For example, the control unit 616 may receive the first film grain parameter 122 from the film grain estimator 518 of FIG. 6. In some examples, the method 1700 includes applying a model to the first set of film grain parameters to generate a second set of film grain parameters associated with the second resolution of another image frame. For example, the model may include or correspond to the model 634. The other image frame may be based on the first image frame. For example, the other image frame may be a downscaled version of the input image frame 104 or a downscaled version of the denoised image frame 562.

Referring to FIG. 18, FIG. 18 is a diagram of an example of a method 1800 of film grain parameter generation, in accordance with some aspects of the present disclosure. In a particular aspect, one or more operations of the method 1800 are performed by the system 100, the encoder device 110, the decoder device 130, the integrated circuit 702, the processor 708, the video engine 720, the encoder 722, the decoder 724, a processor or a combination thereof.

In some embodiments, the method 1800 includes, at block 1802, obtaining a first set of film grain parameters associated with a first image frame having a first resolution. For example, the first set of film grain parameters may include or correspond to the first film grain parameter 122 or the first set of film grain parameters 422. In some embodiments, the first set of film grain parameters include a first set of AR coefficients. The first image frame may include or correspond to the input image frame 104, the image frame 162, the first image frame 262, the denoised image frame 562, or a combination thereof. In some examples, to obtain the first set of film grain parameters, the control unit 244 of FIG. 2 or the control unit 616 of FIG. 6 receives the first film grain parameter 122.

The method 1800 also includes, at block 1804, applying a model to the first set of film grain parameters to obtain a second set of film grain parameters associated with a second image frame having a second resolution. For example, the second set of film grain parameters may include or correspond to the second film grain parameter 172 or the second set of film grain parameters 472. In some embodiments, the second set of film grain parameters include a second set of AR coefficients. The model may include or correspond to the model 234, 404, or 634. Additionally, or alternatively, the model may include a kernel, a linear function, a non-linear function, or a trained model that was trained using a neural network. In some such examples, the model includes a luma channel, a chroma channel, or a combination thereof. The second image frame may include or correspond to the output image frame 180, the second image frame 263, or a combination thereof. The second image frame may be based on the first image frame.

In some embodiments, the first set of film grain parameters are obtained from a bitstream from an encoder. For example, the encoder may include or correspond to the encoder device 110, the video encoder 112, or the encoder engine 517. The bitstream may include or correspond to the bitstream data 160. To further illustrate, the decoder device 130, the input interface 132, the video decoder 134, or the decoder engine 236 may receive the bitstream data 160 from the encoder. In some examples, the method 1800 includes obtaining an indicator, such as a downscale indicator, a film grain indicator, or a combination thereof. For example, the indicator may include or correspond to the indicator 265 or the input 210. The downscale indicator may include or indicate the second resolution. The method 1800 may include obtaining, based on the downscale indictor, a downscaler configuration to downscale the first image frame having the first resolution to obtain the second image frame having the second resolution. The film grain indicator may include or indicate whether film grain should be applied, a lag value, the first resolution, the second resolution, or a combination thereof. The method 1800 may include selecting and/or applying a model based on the film grain indicator. To illustrate, the control unit 244 may select the model 234 from the memory 233 and apply the model 234 to the first film grain parameter 122 to obtain (e.g., generate) the second film grain parameter 172. Additionally, or alternatively, the method 1800 can include obtaining downscaling information. The downscaling information can include or indicate a lag size, an input resolution, an output resolution, a downscaling factor, or a combination thereof. The downscaling information may include or correspond to the indicator 265, the input 210, or a combination thereof. The model may be selected based on the downscaling information. For example, the model 234 may be selected based on the lag size and the output resolution (e.g., the second resolution).

In some embodiments, a bitstream that is output to a decoder can include the second set of film grain parameters and a first image frame having the first resolution. The bitstream may include or correspond to the bitstream data 160 and may be output by an encoder that includes or corresponds to the encoder device 110, the video encoder 112, or the encoder engine 517. The decoder may include or correspond to the decoder device 130, the input interface 132, the video decoder 134, or the decoder engine 236 may receive the bitstream data 160. In some embodiments, the method 1800 includes generating, by the encoder, image data that includes the first image frame. The image data may include or correspond to the image frame 162.

The methods of FIGS. 16-18 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1600, 1700, or 1800 may be performed by a processor that executes instructions, such as described with reference to FIG. 19.

It is noted that one or more blocks (or operations) described with reference to FIGS. 16-18 may be combined with one or more blocks (or operations) described with reference to another of the figures. For example, one or more blocks (or operations) of FIG. 16 may be combined with one or more blocks (or operations) of FIG. 18. As another example, one or more blocks (or operations) of FIG. 17 may be combined with one or more blocks (or operations) of FIG. 18. As another example, one or more blocks associated with FIGS. 16-18 may be combined with one or more blocks (or operations) associated with FIGS. 1-15. To illustrate, one or more blocks associated with FIG. 16 or 18 may be combined with one or more blocks (or operations) associated with FIG. 3. Additionally, or alternatively, one or more operations described above with reference to FIGS. 1-18 may be combined with one or more operations described with reference to FIG. 19.

Referring to FIG. 19, FIG. 19 is a block diagram of an illustrative example of a device 1900 that is operable to support film grain synthesis, in accordance with one or more aspects of the present disclosure. In various implementations, the device 1900 may have more or fewer components than illustrated in FIG. 19. In an illustrative implementation, the device 1900 may correspond to the encoder device 110 or the decoder device 130. In an illustrative implementation, the device 1900 may perform one or more operations described with reference to FIGS. 1-18.

In a particular implementation, the device 1900 includes a processor 1906 (e.g., a central processing unit (CPU)). The device 1900 may include one or more additional processors 1910 (e.g., one or more DSPs). In a particular aspect, the processor 708 of FIG. 7 corresponds to the processor 1906, the processors 1910, or a combination thereof. The processors 1910 may include a speech and music coder-decoder (CODEC) 1908 that includes a voice coder (“vocoder”) encoder 1936, a vocoder decoder 1938, or a combination thereof. Additionally, or alternatively, the processors 1910 may include a video engine 1980, such as a video codec. The video engine may include or correspond to the video engine 720. The video engine 1980 includes an encoder 1982, a decoder 1984, or a combination thereof. The encoder 1982 may include or correspond to the encoder device 110, the video encoder 112, the encoder engine 517, the encoder 722, or a combination thereof. The decoder 1984 may include or correspond to the decoder device 130, the video decoder 134, the decoder engine 236, the decoder 724, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a graphics processing unit (GPU) are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1900 may include a memory 1986 and a CODEC 1934. The memory 1986 may include or correspond to the memory 233, 613, or 706. The memory 1986 may include instructions 1956, that are executable by the one or more additional processors 1910 (or the processor 1906) to implement the functionality described with reference to the video engine 1980—e.g., the encoder 1982, the decoder 1984, or both. The memory 1986 also includes film grain information 1958. The film grain information 1958 may include or correspond to the first film grain parameter 122, the film grain information 164, the second film grain parameter 172, the first set of film grain parameters 422, the second set of film grain parameters 472, or a combination thereof. In some implementations, the memory 1986 may also include one or more models, such as model 234, 404, or 634. The device 1900 may include the modem 1970 coupled, via a transceiver 1950, to an antenna 1952.

The device 1900 may include a display 1928 coupled to a display controller 1926. The display 1928 may include or correspond to the display device 142. The device 1900 may also include or is coupled to one or more cameras 1945, such as the source device 102. One or more speakers 1992, the microphone(s) 1994 may be coupled to the CODEC 1934. The CODEC 1934 may include a digital-to-analog converter (DAC) 1902, an analog-to-digital converter (ADC) 1904, or both. In a particular implementation, the CODEC 1934 may receive analog signals from the microphone(s) 1994, convert the analog signals to digital signals using the analog-to-digital converter 1904, and provide the digital signals to the speech and music codec 1908. In a particular implementation, the speech and music codec 1908 may provide digital signals to the CODEC 1934. The CODEC 1934 may convert the digital signals to analog signals using the digital-to-analog converter 1902 and may provide the analog signals to the speaker 1992.

In a particular implementation, the device 1900 may be included in a system-in-package or system-on-chip device 1922. In a particular implementation, the memory 1986, the processor 1906, the processors 1910, the display controller 1926, the CODEC 1934, and the modem 1970 are included in the system-in-package or system-on-chip device 1922. In a particular implementation, an input device 1930, a power supply 1944, and a camera 1945 are coupled to the system-in-package or the system-on-chip device 1922. Moreover, in a particular implementation, as illustrated in FIG. 19, the display 1928, the input device 1930, the speaker(s) 1992, the microphone(s) 1994, the antenna 1952, the power supply 1944, and the camera 1945 are external to the system-in-package or the system-on-chip device 1922. In a particular implementation, each of the display 1928, the input device 1930, the speaker(s) 1992, the microphone(s) 1994, the antenna 1952, the power supply 1944, and the camera 1945 may be coupled to a component of the system-in-package or the system-on-chip device 1922, such as an interface or a controller.

The device 1900 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for downscaling a first image frame having a first resolution to obtain a second image frame having a second resolution. For example, the means for downscaling can include the decoder device 130, the video decoder 134, the downscaler unit 238, the integrated circuit 702, the processor 708, the video engine 720, the decoder 724, the processor 1906, the processor(s) 1910, the system-in-package or the system-on-chip device 1922, the device 1900, the video engine 1980, the decoder 1984, other circuitry configured to downscale the first image frame, or a combination thereof.

The apparatus also includes means for obtaining, based on film grain information, film grain data associated with the second resolution. For example, the means for obtaining can include the decoder device 130, the video decoder 134, the film grain synthesizer 240, the adder 242, the integrated circuit 702, the processor 708, the video engine 720, the decoder 724, the processor 1906, the processor(s) 1910, the system-in-package or the system-on-chip device 1922, the device 1900, the video engine 1980, the decoder 1984, other circuitry configured to obtain the film grain information, or a combination thereof.

The apparatus further includes means for outputting an output image frame based on the second image frame and the film grain data. For example, the means for outputting can include the decoder device 130, the video decoder 134, the adder 242, the integrated circuit 702, the processor 708, the video engine 720, the decoder 724, the processor 1906, the processor(s) 1910, the system-in-package or the system-on-chip device 1922, the device 1900, the video engine 1980, the decoder 1984, the modem 1970, other circuitry configured to output the output image frame, or a combination thereof.

In conjunction with the described implementations, an apparatus includes means for generating a representation of a first image frame having a first resolution. For example, the means for generating the representation of the first image frame can include the encoder device 110, the video encoder 112, the encoder engine 517, the integrated circuit 702, the processor 708, the video engine 720, the encoder 722, the processor 1906, the processor(s) 1910, the system-in-package or the system-on-chip device 1922, the device 1900, the video engine 1980, the encoder 1982, other circuitry configured to generate the representation of the first image frames, or a combination thereof.

The apparatus also includes means for generating film grain information that indicates a first set of film grain parameters associated with the first resolution and a second set of film grain parameters associated with a second resolution that is different from the first resolution. For example, the means for generating the film grain information can include the encoder device 110, the video encoder 112, the film grain estimator 518, the control unit 616, the integrated circuit 702, the processor 708, the video engine 720, the encoder 722, the processor 1906, the processor(s) 1910, the system-in-package or the system-on-chip device 1922, the device 1900, the video engine 1980, the encoder 1982, other circuitry configured to generate the film grain information, or a combination thereof.

The apparatus further includes means for outputting, to a decoder, an output data that includes and the representation of the first image frame and the film grain information. For example, the means for outputting can include the encoder device 110, the video encoder 112, the output interface 114, the encoder engine 517, the integrated circuit 702, the processor 708, the video engine 720, the encoder 722, the output 705, the processor 1906, the processor(s) 1910, the system-in-package or the system-on-chip device 1922, the device 1900, the video engine 1980, the encoder 1982, the modem 1970, other circuitry configured to output the output data, or a combination thereof.

In conjunction with the described implementations, an apparatus includes means for obtaining a first set of film grain parameters associated with a first image frame having a first resolution. For example, the means for obtaining can include the encoder device 110, the video encoder 112, the decoder device 130, the video decoder 134, the decoder engine 236, the control unit 244, the film grain estimator 518, the encoder engine 517, the control unit 616, the integrated circuit 702, the processor 708, the video engine 720, the encoder 722, the decoder 724, the processor 1906, the processor(s) 1910, the system-in-package or the system-on-chip device 1922, the device 1900, the video engine 1980, the encoder 1982, the decoder 1984, other circuitry configured to obtain the first set of film grain parameters, or a combination thereof.

The apparatus also includes means for applying a model to the first set of film grain parameters to obtain a second set of film grain parameters associated with a second image frame having a second resolution. For example, the means for applying can include the encoder device 110, the video encoder 112, the decoder device 130, the video decoder 134, the control unit 244, the control unit 616, the integrated circuit 702, the processor 708, the video engine 720, the encoder 722, the decoder 724, the processor 1906, the processor(s) 1910, the system-in-package or the system-on-chip device 1922, the device 1900, the video engine 1980, the encoder 1982, the decoder 1984, other circuitry configured to apply the model, or a combination thereof. The second image frame is based on the first image frame.

In some implementations, a non-transitory computer-readable medium (e.g., a computer-readable storage device, such as the memory 1986) includes instructions (e.g., the instructions 1956) that, when executed by one or more processors (e.g., the one or more processors 1910 or the processor 1906), cause the one or more processors to downscale a first image frame having a first resolution to obtain a second image frame having a second resolution. The instructions, when executed by the one or more processors, also cause the one or more processors to obtain, based on film grain information, film grain data associated with the second resolution. The instructions, when executed by the one or more processors, also cause the one or more processors to output an output image frame based on the second image frame and the film grain data.

In some implementations, a non-transitory computer-readable medium (e.g., a computer-readable storage device, such as the memory 1986) includes instructions (e.g., the instructions 1956) that, when executed by one or more processors (e.g., the one or more processors 1910 or the processor 1906), cause the one or more processors to generate a representation of a first image frame having a first resolution. The instructions, when executed by the one or more processors, further cause the one or more processors to generate film grain information that indicates a first set of film grain parameters associated with the first resolution and a second set of film grain parameters associated with a second resolution that is different from the first resolution. The instructions, when executed by the one or more processors, also cause the one or more processors to output, to a decoder, an output data that includes and the representation of the first image frame and the film grain information.

In some implementations, a non-transitory computer-readable medium (e.g., a computer-readable storage device, such as the memory 1986) includes instructions (e.g., the instructions 1956) that, when executed by one or more processors (e.g., the one or more processors 1910 or the processor 1906), cause the one or more processors to obtain a first set of film grain parameters associated with a first image frame having a first resolution. The instructions, when executed by the one or more processors, further cause the one or more processors to apply a model to the first set of film grain parameters to obtain a second set of film grain parameters associated with a second image frame having a second resolution. The second image frame is based on the first image frame.

Particular aspects of the disclosure are described below in sets of interrelated Examples:

According to Example 1, a device includes a memory configured to store film grain information; and one or more processors coupled to the memory and configured to downscale a first image frame having a first resolution to obtain a second image frame having a second resolution; obtain, based on the film grain information, film grain data associated with the second resolution; and output an output image frame based on the second image frame and the film grain data.

Example 2 includes the device of Example 1, and the one or more processors are configured to obtain, from an encoder, a bitstream that includes a representation of one or more image frames; decode the bitstream to obtain the first image frame having the first resolution; and add the film grain data to the second image frame to obtain the output image frame.

Example 3 includes the device of Example 2, and the one or more processors are configured to obtain, based on the bitstream, a downscale indicator, a film grain indicator, or a combination thereof.

Example 4 includes the device of Example 1, and the one or more processors are configured to obtain, from an encoder, a bitstream that includes a representation of one or more image frames; and obtain, based on the bitstream, a second set of film grain parameters associated with the second resolution, wherein the film grain data is based on the second set of film grain parameters.

Example 5 includes the device of Example 1, and the one or more processors are configured to obtain, from an encoder, a first set of film grain parameters associated with the first resolution; and apply a model to the first set of film grain parameters to generate a second set of film grain parameters associated with the second resolution of a second image frame, where the second image frame is based on the first image frame.

Example 6 includes the device of Example 5, and the one or more processors are configured to obtain the film grain information based on the second set of film grain parameters.

Example 7 includes the device of any of Examples 1-6, and the device further includes video decoder hardware that includes the one or more processors; and where the first resolution is a higher resolution than the second resolution; and the film grain information is in compliance with an AV1 format.

Example 8 includes the device of any of Examples 1-7, and the device further includes a display device coupled to the one or more processors, the display device configured to display the output image frame.

Example 9 includes the device of any of Examples 1-8, and the device further includes a modem coupled to the one or more processors, the modem configured to receive a bitstream from an encoder for playout of the output image frame by the device.

Example 10 includes the device of any of Examples 1-9, where the one or more processors are integrated in a mobile phone, a tablet computer device, a wearable electronic device, a virtual reality headset, a mixed reality headset, or an augmented reality headset.

Example 11 includes the device of any of Examples 1-9, where the one or more processors are integrated in a vehicle that includes a display device, and where the display device is configured to display the output image frame.

According to Example 12, a method includes downscaling a first image frame having a first resolution to obtain a second image frame having a second resolution; obtaining, based on film grain information, film grain data associated with the second resolution; and outputting an output image frame based on the second image frame and the film grain data.

Example 13 includes the method of Example 12, the method further includes obtaining, from an encoder, a bitstream that includes a representation of one or more image frames; and decoding the bitstream to obtain the first image frame having the first resolution; and adding the film grain data to the second image frame to obtain the output image frame.

Example 14 includes the method of Example 13, the method further includes obtaining, based on the bitstream, a downscale indicator, a film grain indicator, or a combination thereof.

Example 15 includes the method of Example 12, the method further includes obtaining, from an encoder, a bitstream that includes a representation of one or more image frames; and obtaining, based on the bitstream, a second set of film grain parameters associated with the second resolution, where the film grain data is based on the second set of film grain parameters.

Example 16 includes the method of Example 12, the method further includes obtaining, from an encoder, a first set of film grain parameters associated with the first resolution; and applying a model to the first set of film grain parameters to generate a second set of film grain parameters associated with the second resolution of a second image frame, where the second image frame is based on the first image frame.

Example 17 includes the method of Example 16, the method further includes obtaining the film grain information based on the second set of film grain parameters.

Example 18 includes the method of any of Examples 12-16, where the first resolution is a higher resolution than the second resolution.

Example 19 includes the method of any of Examples 12-17, where the film grain information is in compliance with an AV1 format.

Example 20 includes the method of any of Examples 12-19, the method further includes receiving, via a modem, a bitstream from an encoder for playout of the output image frame.

Example 21 includes the method of any of Examples 12-21, the method further includes displaying, via a display device, the output image frame.

Example 22 includes the method of Example 21, where the display device is included in a vehicle.

Example 23 includes the method of Example 22, where the output image frame is output by a mobile phone, a tablet computer device, a wearable electronic device, a virtual reality headset, a mixed reality headset, or an augmented reality headset.

According to Example 24, an apparatus includes means for downscaling a first image frame having a first resolution to obtain a second image frame having a second resolution; means for obtaining, based on film grain information, film grain data associated with the second resolution; and means for outputting an output image frame based on the second image frame and the film grain data.

According to Example 25, a non-transitory computer-readable medium storing instructions that are executable by one or more processors to cause the one or more processors to downscale a first image frame having a first resolution to obtain a second image frame having a second resolution; obtain, based on film grain information, film grain data associated with the second resolution; and output an output image frame based on the second image frame and the film grain data.

According to Example 26, a device includes a memory configured to store film grain information; and one or more processors coupled to the memory and configured to generate a representation of a first image frame having a first resolution; generate the film grain information that indicates a first set of film grain parameters associated with the first resolution and a second set of film grain parameters associated with a second resolution that is different from the first resolution; and output, to a decoder, an output data that includes and the representation of the first image frame and the film grain information.

Example 27 includes the device of Example 26, where the one or more processors are configured to obtain a second image frame having the first resolution; and perform a denoise operation on the second image frame to obtain the first image frame having the first resolution.

Example 28 includes the device of Example 27, where the one or more processors are configured to obtain first residual information based on the first image frame and the second image frame, the first residual information associated with the first resolution; and obtain, based on the first image frame and the first residual information, the first set of film grain parameters associated with the first resolution.

Example 29 includes the device of Example 27, where the one or more processors are configured to obtain, based on the first image frame, a third image frame having the second resolution; and obtain, based on the second image frame, a fourth image frame having the second resolution; and obtain, based on the fourth image frame, the second set of film grain parameters associated with the second resolution.

Example 30 includes the device of Example 29, where the one or more processors are configured to obtain second residual information based on the third image frame and the fourth image frame, the second residual information associated with the second resolution; and the second set of film grain parameters are based on the second residual information.

Example 31 includes the device of any of Examples 26-30, the device further includes video encoder hardware that includes the one or more processors.

Example 32 includes the device of any of Examples 26-31, where the first resolution is a higher resolution than the second resolution.

Example 33 includes the device of any of Examples 26-32, where the film grain information is in compliance with an AV1 format.

Example 34 includes the device of Example 26, where the one or more processors are configured to obtain the first set of film grain parameters associated with the first resolution; and apply a model to the first set of film grain parameters to generate a second set of film grain parameters associated with the second resolution of another image frame, where the other image frame is based on the first image frame.

Example 35 includes the device of any of Examples 26-34, the device further includes one or more cameras coupled to the one or more processors and configured to generate image data that includes the first image frame.

Example 36 includes the device of any of Examples 26-35, the device further includes a modem coupled to the one or more processors, the modem configured to transmit, to the decoder, a bitstream that includes the output data.

According to Example 37, a method includes generating a representation of a first image frame having a first resolution; generating film grain information that indicates a first set of film grain parameters associated with the first resolution and a second set of film grain parameters associated with a second resolution that is different from the first resolution; and outputting, to a decoder, an output data that includes and the representation of the first image frame and the film grain information.

Example 38 includes the method of Example 37, the method further includes obtaining a second image frame having the first resolution; and performing a denoise operation on the second image frame to obtain the first image frame having the first resolution.

Example 39 includes the method of Example 38, the method further includes obtaining first residual information based on the first image frame and the second image frame, the first residual information associated with the first resolution; and obtaining, based on the first image frame and the first residual information, the first set of film grain parameters associated with the first resolution.

Example 40 includes the method of Example 38, the method further includes obtaining, based on the first image frame, a third image frame having the second resolution; and obtaining, based on the second image frame, a fourth image frame having the second resolution; and obtaining, based on the fourth image frame, the second set of film grain parameters associated with the second resolution.

Example 41 includes the method of Example 40, the method further includes obtaining second residual information based on the third image frame and the fourth image frame, the second residual information associated with the second resolution; and where the second set of film grain parameters are based on the second residual information.

Example 42 includes the method of any of Examples 37 to 41, where the first resolution is a higher resolution than the second resolution.

Example 43 includes the method of any of Examples 37 to 42, where the film grain information is in compliance with an AV1 format.

Example 44 includes the method of any of Examples 37 to 43, the method further includes obtaining the first set of film grain parameters associated with the first resolution; and applying a model to the first set of film grain parameters to generate a second set of film grain parameters associated with the second resolution of another image frame, where the other image frame is based on the first image frame.

Example 45 includes the method of any of Examples 37 to 44, the method further includes generating, at one or more cameras, image data that includes the first image frame.

Example 46 includes the method of any of Examples 37 to 45, the method further includes transmitting, to a decoder via a modem, a bitstream that includes the output data.

According to Example 47, an apparatus includes means for generating a representation of a first image frame having a first resolution; means for generating film grain information that indicates a first set of film grain parameters associated with the first resolution and a second set of film grain parameters associated with a second resolution that is different from the first resolution; and means for outputting, to a decoder, an output data that includes and the representation of the first image frame and the film grain information.

According to Example 48, a non-transitory computer-readable medium storing instructions that are executable by one or more processors to cause the one or more processors to generate a representation of a first image frame having a first resolution; generate film grain information that indicates a first set of film grain parameters associated with the first resolution and a second set of film grain parameters associated with a second resolution that is different from the first resolution; and output, to a decoder, an output data that includes and the representation of the first image frame and the film grain information.

According to Example 49, a device includes a memory configured to store a first set of film grain parameters associated with a first resolution of a first image frame; and one or more processors coupled to the memory and configured to obtain the first set of film grain parameters associated with the first resolution; and apply a model to the first set of film grain parameters to generate a second set of film grain parameters associated with a second resolution of a second image frame, where the second image frame is based on the first image frame.

Example 50 includes the device of Example 49, where the first set of film grain parameters include a first set of AR coefficients; and the second set of film grain parameters include a second set of AR coefficients; and the one or more processors are configured to obtain a downscale indicator that indicates the second resolution.

Example 51 includes the device of Example 49 or Example 50, where the one or more processors are configured to obtain a film grain indicator; and the model is applied based on the film grain indicator.

Example 52 includes the device of Example 51, where the one or more processors are configured to obtain downscaling information that indicates a lag size, an input resolution, an output resolution, a downscaling factor, or a combination thereof; and based on the downscaling information, select the model from one or more models.

Example 53 includes the device of any of Examples 51-52, where the model includes a kernel, a linear function, a non-linear function, or a model trained using a neural network.

Example 54 includes the device of any of Examples 51-53, where the model includes a luma channel, a chroma channel, or a combination thereof.

Example 55 includes the device of any of Examples 49-54, where the one or more processors are included in video decoder hardware.

Example 56 includes the device of Example 55, where the first set of film grain parameters are obtained from a bitstream from an encoder.

Example 57 includes the device of any of Examples 49-54, where the one or more processors are included in video encoder hardware.

Example 58 includes the device of Example 57, where the second set of film grain parameters and a first image frame having the first resolution are included in a bitstream output to a decoder.

Example 59 includes the device of Example 58, the device further includes one or more cameras coupled to the one or more processors and configured to generate image that includes the first image frame.

According to Example 60, a method includes obtaining a first set of film grain parameters associated with a first image frame having a first resolution; and applying a model to the first set of film grain parameters to obtain a second set of film grain parameters associated with a second image frame having a second resolution, where the second image frame is based on the first image frame.

Example 61 includes the method of Example 60, the method further includes obtaining a downscale indicator that indicates the second resolution; and obtaining, based on the downscale indicator, a downscaler configuration to downscale the first image frame having the first resolution to obtain the second image frame having the second resolution.

Example 62 includes the method of Example 60 or Example 61, where the first set of film grain parameters include a first set of AR coefficients; and the second set of film grain parameters include a second set of AR coefficients.

Example 63 includes the method of any of Examples 60-62, the method further includes obtaining downscaling information that indicates a lag size, an input resolution, an output resolution, a downscaling factor, or a combination thereof; and based on the downscaling information, selecting the model from one or more models.

Example 64 includes the method of any of Examples 60-63, the method further includes obtaining a film grain indicator.

Example 65 includes the method of Example 64, the method further includes applying, based on the film grain indicator, a model to the first set of film grain parameters to obtain the second set of film grain parameters.

Example 66 includes the method of any of Examples 60-65, where the model includes a kernel, a linear function, a non-linear function, or a model trained using a neural network.

Example 67 includes the method of any of Examples 60-66, where the model includes a luma channel, a chroma channel, or a combination thereof.

Example 68 includes the method of any of Examples 60-67, where the first set of film grain parameters are obtained from a bitstream from an encoder.

Example 69 includes the method of any of Examples 60-67, where the second set of film grain parameters and a first image frame having the first resolution are included in a bitstream output to a decoder.

Example 70 includes the method of Example 69, the method further includes generating image data that includes the first image frame.

According to Example 71, an apparatus includes means for obtaining a first set of film grain parameters associated with a first image frame having a first resolution; and means for applying a model to the first set of film grain parameters to obtain a second set of film grain parameters associated with a second image frame having a second resolution, where the second image frame is based on the first image frame.

According to Example 72, a non-transitory computer-readable medium storing instructions that are executable by one or more processors to cause the one or more processors to obtain a first set of film grain parameters associated with a first image frame having a first resolution; and apply a model to the first set of film grain parameters to obtain a second set of film grain parameters associated with a second image frame having a second resolution, where the second image frame is based on the first image frame.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store film grain information; and
one or more processors coupled to the memory and configured to:
downscale a first image frame having a first resolution to obtain a second image frame having a second resolution;
obtain, based on the film grain information, film grain data associated with the second resolution; and
output an output image frame based on the second image frame and the film grain data.

2. The device of claim 1, wherein the one or more processors are configured to:
obtain, from an encoder, a bitstream that includes a representation of one or more image frames; and
decode the bitstream to obtain the first image frame having the first resolution; and
the one or more processors are configured to add the film grain data to the second image frame to obtain the output image frame.

3. The device of claim 2, wherein the one or more processors are configured to obtain, based on the bitstream, a downscale indicator, a film grain indicator, or a combination thereof.

4. The device of claim 1, wherein the one or more processors are configured to:
obtain, from an encoder, a bitstream that includes a representation of one or more image frames; and
obtain, based on the bitstream, a second set of film grain parameters associated with the second resolution, wherein the film grain data is based on the second set of film grain parameters.

5. The device of claim 1, wherein the one or more processors are configured to:
obtain, from an encoder, a first set of film grain parameters associated with the first resolution; and
apply a model to the first set of film grain parameters to generate a second set of film grain parameters associated with the second resolution of a second image frame, wherein the second image frame is based on the first image frame.

6. The device of claim 5, wherein the one or more processors are configured to obtain the film grain data based on the second set of film grain parameters.

7. The device of claim 1, further comprising:
video decoder hardware that includes the one or more processors; and
wherein:
the first resolution is a higher resolution than the second resolution; and
the film grain information is in compliance with an alliance for open media video 1 (AV1) format.

8. The device of claim 1, further comprising a display device coupled to the one or more processors, the display device configured to display the output image frame.

9. The device of claim 1, further comprising a modem coupled to the one or more processors, the modem configured to receive a bitstream from an encoder for playout of the output image frame by the device.

10. The device of claim 1, wherein the one or more processors are integrated in a mobile phone, a tablet computer device, a wearable electronic device, a virtual reality headset, a mixed reality headset, or an augmented reality headset.

11. The device of claim 1, wherein the one or more processors are integrated in a vehicle that includes a display device, and wherein the display device is configured to display the output image frame.

12. A device comprising:
a memory configured to store film grain information; and
one or more processors coupled to the memory and configured to:
generate a representation of a first image frame having a first resolution;
generate the film grain information that indicates a first set of film grain parameters associated with the first resolution and a second set of film grain parameters associated with a second resolution that is different from the first resolution; and
output, to a decoder, output data that includes the representation of the first image frame and the film grain information.

13. The device of claim 12, wherein the one or more processors are configured to:
obtain a second image frame having the first resolution; and
perform a denoise operation on the second image frame to obtain the first image frame having the first resolution.

14. The device of claim 13, wherein the one or more processors are configured to:
obtain first residual information based on the first image frame and the second image frame, the first residual information associated with the first resolution; and
obtain, based on the first image frame and the first residual information, the first set of film grain parameters associated with the first resolution.

15. The device of claim 13, wherein the one or more processors are configured to:
obtain, based on the first image frame, a third image frame having the second resolution; and
obtain, based on the second image frame, a fourth image frame having the second resolution; and
obtain, based on the fourth image frame, the second set of film grain parameters associated with the second resolution.

16. The device of claim 15, wherein:
the one or more processors are configured to obtain second residual information based on the third image frame and the fourth image frame, the second residual information associated with the second resolution; and
the second set of film grain parameters are based on the second residual information.

17. The device of claim 12, further comprising:
video encoder hardware that includes the one or more processors; and
wherein:
the first resolution is a higher resolution than the second resolution; and
the film grain information is in compliance with an alliance for open media video 1 (AV1) format.

18. The device of claim 12, wherein the one or more processors are configured to:
obtain the first set of film grain parameters associated with the first resolution; and
apply a model to the first set of film grain parameters to generate a second set of film grain parameters associated with the second resolution of another image frame, wherein the other image frame is based on the first image frame.

19. The device of claim 12, further comprising one or more cameras coupled to the one or more processors and configured to generate the image data that is stored at the memory.

20. The device of claim 12, further comprising a modem coupled to the one or more processors, the modem configured to transmit, to the decoder, a bitstream that includes the output data.

21. A device comprising:
a memory configured to store a first set of film grain parameters associated with a first resolution of a first image frame; and
one or more processors coupled to the memory and configured to:
obtain the first set of film grain parameters associated with the first resolution; and
apply a model to the first set of film grain parameters to generate a second set of film grain parameters associated with a second resolution of a second image frame, wherein the second image frame is based on the first image frame.

22. The device of claim 21, wherein:
the first set of film grain parameters include a first set of auto-regressive (AR) coefficients; and
the second set of film grain parameters include a second set of AR coefficients; and
the one or more processors are configured to obtain a downscale indicator that indicates the second resolution.

23. The device of claim 21, wherein:
the one or more processors are configured to obtain a film grain indicator; and
the model is applied based on the film grain indicator.

24. The device of claim 23, wherein the one or more processors are configured to:
obtain downscaling information that indicates a lag size, an input resolution, an output resolution, a downscaling factor, or a combination thereof; and
based on the downscaling information, select the model from one or more models.

25. The device of claim 23, wherein the model includes a kernel, a linear function, a non-linear function, or a model trained using a neural network.

26. The device of claim 23, wherein the model includes a luma channel, a chroma channel, or a combination thereof.

27. The device of claim 21, wherein:
the one or more processors are included in video decoder hardware; and
the first set of film grain parameters are obtained from a bitstream from an encoder.

28. The device of claim 21, wherein:
the one or more processors are included in video encoder hardware; and
the second set of film grain parameters and a first image frame having the first resolution are included in a bitstream output to a decoder.

29. The device of claim 28, further comprising one or more cameras coupled to the one or more processors and configured to generate image data that is stored at the memory, wherein the image data includes the first image frame.

30. A method comprising:
obtaining a first set of film grain parameters associated with a first image frame having a first resolution; and
applying a model to the first set of film grain parameters to obtain a second set of film grain parameters associated with a second image frame having a second resolution, wherein the second image frame is based on the first image frame.
